(19) United States
(12) Patent Application Publication
(10) Pub. No.: US 2015/0023317 A1
(43) Pub. Date: Jan. 22, 2015

(54) COMMUNICATION SYSTEM, COMMUNICATION METHOD, BASE STATION APPARATUS, AND TERMINAL APPARATUS

(71) Applicant: Sharp Kabushiki Kaisha, Osaka-shi, Osaka (JP)

(72) Inventors: Kozue Yokomakura, Osaka-shi (JP); Ryota Yamada, Osaka-shi (JP); Takashi Yoshimoto, Osaka-shi (JP); Katsuya Kato, Osaka-shi (JP)

(73) Assignee: Sharp Kabushiki Kaisha, Osaka-shi, Osaka (JP)

(21) Appl. No.: 14/385,248

(22) PCT Filed: Mar. 11, 2013
(86) PCT No.: PCT/JP2013/056583

§ 371 Date: Sep. 15, 2014

(30) Foreign Application Priority Data
Mar. 16, 2012 (JP) 2012-060736

(51) Int. Cl. H04J 11/00; H04L 5/00; H04W 72/04

(52) U.S. Cl. CPC H04J 11/0056; H04W 72/0426; H04L 5/0007; H04W 88/08
USPC 370/330

(57) ABSTRACT

Frequency utilization efficiency is increased while inter-cell interference is controlled.

A communication system 1 includes a base station apparatus and at least one terminal apparatus communicating with each other in each of a plurality of communication areas, with the communication areas adjacent to or overlapping each other. A macro cell base station apparatus 100 in one of the communication areas allocates the same frequency bandwidth to the terminal apparatuses in the communication areas. The macro cell base station apparatus 100 calculates a transmit weight and a receive weight according to which the terminals having the same frequency bandwidth allocated thereto perform coordinated control.

### TECHNICAL FIELD

The present invention relates to a communication system, a communication method, a base station apparatus, and a terminal apparatus.

### BACKGROUND ART

Distribution of a traffic load of a macrocell base station among small-scale base stations is under study in the field of the next generation mobile communication system. The small-scale base station apparatus, such as a picocell base station or a femtocell base station, is installed in the next generation mobile communication system, and a terminal connected to the macrocell base station is off-loaded to the small-scale base stations. However, since the small-scale base station (such as a picocell base station) has transmission power lower than that of the macrocell base station, the number of terminals that are off-loaded from the macrocell base station to the picocell base station is limited. The traffic distribution through the installation of the picocell base station is not sufficiently effective.

CRE (Cell Range Expansion) has been proposed in 3GPP (3rd Generation Partnership Project). CRE provides an equivalent offset in the transmission power of the picocell base station, and increases an apparent cell radius of the picocell base station. In this way, particularly, a terminal that is present in a boundary between the macrocell and the picocell is enabled to switch a connection destination from the macrocell base station to the picocell base station. The traffic load of the macrocell base station is thus distributed among the picocell base stations.

With CRE applied, particularly, a terminal that switches the connection destination from the macrocell base station to the picocell base station suffers from inter-cell interference from the macrocell base station. Since the macrocell base station is then higher in transmission power than the picocell base station, interference from the macrocell base station is strong. A method to allocate a different time resource to each cell as described in Non Patent Literature 1 is under study as a method to suppress the effect of such inter-cell interference. The effect of the inter-cell interference is avoided by allocating difference time resources different from cell to each cell.

### CITATION LIST

### Non Patent Literature

NPL 1: 3GPP TS 36.300 V10.5.0 (Release 10)

### SUMMARY OF INVENTION

### Technical Problem

Many of the next generation mobile communication systems adopt OFDMA (Orthogonal Frequency Division Multiple Access) as a multiple access method. Data of multiple terminals are allocated based on a region, including a specific frequency bandwidth and a time duration, as an allocation unit.

FIG. 1 illustrates a simple example denoting a structure of a communication frame. In FIG. 1, the ordinate represents frequency while the abscissa represents time. The communication frame includes six resource blocks (RBs) along the frequency axis. The six resource blocks are an area enclosed by a solid line. Here, RB is a minimum unit of radio resource allocation. As illustrated in FIG. 1, only one of the RBs along the time axis included in the communication frame is illustrated for simplicity of explanation. As in an enlarged view 11 of RB1 of FIG. 1, a single RB includes 12 subcarriers and 7 symbols.

Since reception quality is different from frequency to frequency on each terminal, reception quality is also different from allocated resource block to allocated resource block. For this reason, the base station performs a process called scheduling so that each terminal is allocated a resource block of high reception quality. High throughput transmission is thus achieved.

If the base stations of the cells perform scheduling independently in a multi-cell environment where multiple cells are present, the same resource is allocated between different cells causing inter-cell interference. For example, three resource blocks may be allocated to a single cell in a system including one macrocell and one picocell. If the same resource blocks (for example, RB1, RB2, and RB3 in FIG. 1) are allocated to a macrocell terminal (a terminal connected to the macrocell base station) and a picocell terminal (a terminal connected the picocell base station), the macrocell base station and the picocell base station transmit using the same frequency, causing inter-cell interference.

The technique disclosed in Non Patent Literature 1 allocates different resources to the terminals having the same resource allocation, thereby suppressing the inter-cell interference. With an increase in the number of cells, however, more resources are needed, and frequency utilization efficiency decreases.

In the above-described example (the resource allocation of the macrocell base station and the picocell base station are RB1, RB2, and RB3 as illustrated in FIG. 1), adjustment is performed between the cells so that the macrocell terminal and the picocell terminal are different in resource allocation, and as a result, six resources (RB1 through RB6 in FIG. 1) are needed.

The present invention has been developed in view of the above problem, and is intended to provide a communication system, a communication method, a base station apparatus, and a terminal apparatus for suppressing the inter-cell interference with the frequency utilization efficiency increased.

### Solution to Problem

(1) The present invention has been developed in view of the above problem, and in one aspect, provides a communication system. The communication apparatus includes a base station apparatus and at least one terminal apparatus communicating with each other using a plurality of resources in each of a plurality of communication areas, with the communication areas adjacent to or overlapping each other. A first base station apparatus as a base station in one of the communication areas calculates transmit weights of the base station apparatuses with respect to the terminal apparatus having the same resource of the resources allocated thereto, and each of the base station apparatuses transmits a signal multiplied by the notified transmit weight to the terminal apparatus.

(2) In another aspect of the present invention, the first base station apparatus in the communication system further calculates a receive weight of each terminal apparatus, and the terminal apparatus performs a demodulation operation using the receive weight.

(3) In another aspect of the present invention, the first base station apparatus in the communication system calculates the transmit weight by a weight unit that is a unit of weight calculation.

(4) In another aspect of the present invention, the first base station apparatus in the communication system calculates the transmit weight and the receive weight by a weight unit as a unit of weight calculation.

(5) In another aspect of the present invention, the weight unit in the communication system is notified from the terminal apparatus to each base station apparatus.

(6) In another aspect of the present invention, the weight unit is notified from each base station apparatus to the terminal apparatus in the communication system.

(7) In another aspect of the present invention, the terminal apparatus in the communication system determines a representative value of channel information by the weight unit using a reference signal, and notifies the base station apparatus of information representing the determined representative value of the channel information.

(8) In another aspect of the present invention, the representative value of the channel information is a mean value of the weight units in the communication system.

(9) In another aspect of the present invention, the representative value of the channel information is channel information of a subcarrier having the reference signal allocated thereto, from among the weight units in the communication system.

(10) In another aspect of the present invention, the first base station apparatus in the communication system calculates the transmit weight by the weight unit using the representative value of the channel information.

(11) In another aspect of the present invention, the first base station apparatus in the communication system calculates the transmit weight or the receive weight by the weight unit using the representative value of the channel information.

(12) In another aspect of the present invention, the first base station apparatus in the communication system calculates the transmit weight by a unit different from the weight unit using the representative value of the channel information.

(13) In another aspect of the present invention, the first base station apparatus in the communication system calculates the transmit weight or the receive weight by a unit different from the weight unit using the representative value of the channel information.

(14) In another aspect of the present invention, a unit of calculation of the transmit weight is different from a unit of calculation of the receive weight in the communication system.

(15) In another aspect of the present invention, the weight unit is a subcarrier unit in the communication system.

(16) In another aspect of the present invention, the weight unit is a unit that is a natural number multiple of a resource block in the communication system.

(17) In another aspect of the present invention, the weight unit is one of a plurality of types of resource block units in the communication system.

(18) In another aspect of the present invention, a weight unit of at least one of the terminal apparatuses is different from a weight unit of the other terminal apparatuses in the communication system.

(19) In another aspect of the present invention, the terminal apparatus generates the receive weight by the weight unit in the communication system.

(20) In another aspect of the present invention, the terminal apparatus generates the receive weight by a unit different from the weight unit in the communication system.

(21) In another aspect of the present invention, the terminal apparatus generates the receive weight by a subcarrier unit in the communication system.

(22) In another aspect of the present invention, the base station apparatuses in the respective communication areas are mutually interconnected through a wired network or a radio network in the communication system. Through the wired network or the radio network, a base station apparatus other than the first base station apparatus notifies the first base station apparatus of the information representing the representative value of the channel information notified by the terminal apparatus.

(23) In another aspect of the present invention, the base station apparatuses in the respective communication areas in the communication system are mutually interconnected through the wired network or the radio network. Through the wired network or the radio network, the first base station apparatus notifies another base station apparatus of the determined transmit weight.

(24) In another aspect of the present invention, the first base station apparatus in the communication system notifies another base station apparatus of the determined receive weight through the wired network or the radio network.

(25) The present invention in another aspect relates to a communication method of a communication system including a base station apparatus and at least one terminal apparatus communicating with each other in each of a plurality of communication areas, with the communication areas adjacent to or overlapping each other. The communication method includes a step of a first base station apparatus as a base station in one of the communication areas for calculating a transmit weight of a base station apparatus coordinated therewith, and notifying each base station apparatus of information indicating the transmit weight, and a step of each base station apparatus for transmitting to the terminal apparatus a signal multiplied by the notified transmit weight.

(26) The present invention in one aspect relates to a base station apparatus. The base station apparatus includes an allocator configured to allocate same resource for use in communications based on a reception quality of each cell, a weight calculator configured to calculate a transmit weight to suppress inter-cell interference on a terminal apparatus to which the allocator has allocated the same resource, a transmit weight multiplier configured to multiply a transmission signal by the transmit weight calculated by the weight calculator, and a transmitting unit configured to transmit, to a terminal apparatus within a communication area, a signal the transmit weight multiplier has obtained through multiplication.

(27) In another aspect of the present invention, the weight calculator in the base station apparatus further calculates a receive weight that the terminal apparatus uses to suppress the inter-cell interference. The transmitting unit notifies the terminal apparatus within the communication area of information indicating the calculated receive weight.

(28) The present invention relates to a terminal apparatus. The terminal apparatus includes a signal demultiplexer configured to demultiplex a transmission signal transmitted from a base station apparatus into a reception data signal and a receive weight, and a receive weight multiplier configured to multiply the reception data signal demultiplexed by the signal demultiplexer by the receive weight demultiplexed by the signal demultiplexer.

(29) In another aspect of the present invention, the terminal apparatus includes a signal demultiplexer configured to demultiplex a transmission signal transmitted by a base station apparatus into a reference signal and control information, a channel estimator configured to estimate an equivalent channel of each subcarrier based on the reference signal demultiplexed by the signal demultiplexer, a receive weight calculator configured to calculate a receive weight based on the equivalent channel of each subcarrier estimated by the channel estimator, and a receive weight multiplier configured to multiply the control information demultiplexed by the signal demultiplexer by the receive weight calculated by the receive weight calculator.

### Advantageous Effects of Invention

According to the present invention, the frequency utilization efficiency is increased with the inter-cell interference controlled.

### BRIEF DESCRIPTION OF DRAWINGS

FIG. 1 illustrates an example of a communication frame structure;

FIG. 2 illustrates a configuration example of a communication system of a first embodiment.

FIG. 3 illustrates a configuration example of the communication system where cells of the same type partially overlap each other.

FIG. 4 is a flowchart illustrating an example of a process flow of the communication system of the first embodiment.

FIG. 5 is a block diagram diagrammatically illustrating the configuration of a macrocell base station of the first embodiment.

FIG. 6 is a block diagram diagrammatically illustrating a higher layer of the first embodiment.

FIG. 7 is a block diagram diagrammatically illustrating the configuration of a picocell base station of the first embodiment.

FIG. 8 is a block diagram diagrammatically illustrating the configuration of a terminal of the first embodiment.

FIG. 9 is a flowchart illustrating a flow of calculation process of transmit and receive weighs in step S105 of FIG. 4.

FIG. 10 illustrates a procedure of the calculation process of FIG. 9 to calculate the transmit weight and receive weights.

FIG. 11 illustrates a configuration example of a communication system of a second embodiment.

FIG. 12 is a flowchart illustrating a process flow of the communication system of the second embodiment.

FIG. 13 is a block diagram diagrammatically illustrating a terminal apparatus of the second embodiment.

FIG. 14 is a block diagram diagrammatically illustrating a macrocell base station of the second embodiment.

FIG. 15 is a block diagram diagrammatically illustrating a higher layer of the second embodiment.

FIG. 16 is a flowchart illustrating a process flow of a transmit and receive weight calculation of the second embodiment.

FIG. 17 illustrates a configuration example of a communication system of a third embodiment.

FIG. 18 is a flowchart illustrating an example of a process flow of the communication system of the third embodiment.

FIG. 19 is a block diagram diagrammatically illustrating a macrocell base station of the third embodiment.

FIG. 20 is a block diagram diagrammatically illustrating a terminal apparatus of the third embodiment.

### DESCRIPTION OF EMBODIMENTS

Embodiments of the present invention are described in detail with reference to the drawings. In each of the present embodiments, a communication system to be described below includes multiple communication areas, in each of which a base station apparatus and at least one terminal apparatus communicate with each other, and the multiple communication areas are adjacent to or overlap each other.

### First Embodiment

In a related art communication system, the effect of inter-cell interference is suppressed by adjusting the resource allocation between cells. The communication system of the present embodiment suppresses the inter-cell interference through coordinated control, and transmit and receive weights for use in the coordinated control are calculated on a per subcarrier basis. The term resource refers to frequency or time.

Coordinated control performed by the present embodiment is briefly described. In the present embodiment, the coordinated control is performed in view of not only channel variations in a host cell but channel variations in the other cells so that the cells may not interfere with each other. Coordinated transmission beam forming technique or IA (Interference Alignment) technique is available as an example of the coordinated control technique.

In the coordinated transmission beam forming technique, a base station multiples a signal by a transmit weight that gives no interferences to cells based on the channel variations with the other cells, and transmits the resulting signal. By multiplying the signal by an appropriate transmit weight and then transmitting the resulting signal, interference with the terminal in the other cell is suppressed.

In the IA technique, each base station and each terminal calculate transmit weights and receive weights in concert with each other so that equivalent channels of interfering signals coming from multiple base stations functioning as interfering sources are orthogonal to the receive weight that the terminal multiplies by a received signal, and transmission and reception are performed using the transmit weight and the receive weight. Through such control, even if a terminal receives interfering signals of a removable number (degree of freedom) from adjacent cells, these interfering signals are removed, and a desired signal is thus extracted from the received signals at a high accuracy.

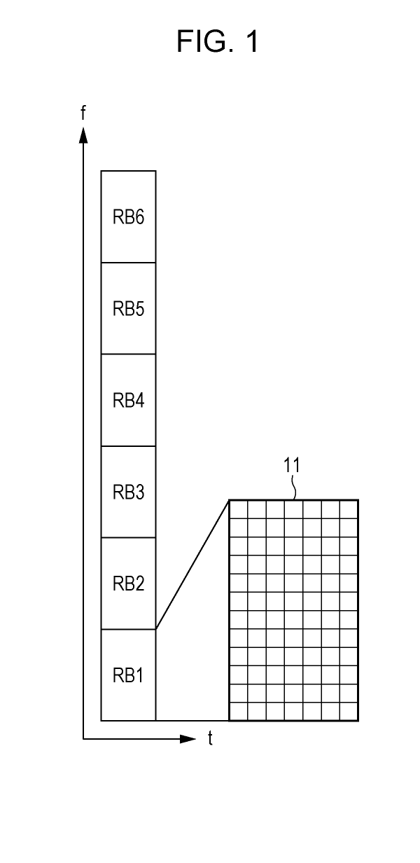

In the present embodiment, the IA technique is used as an example of the coordinated control. But the present embodiment is not limited to the IA technique. The coordinated transmission beam forming technique may also be used. The communication frame handled as a target of the present embodiment includes six resource blocks of FIG. 1, for example. The resource block is defined by frequency (for example, a subcarrier count), and time (for example, a symbol count).

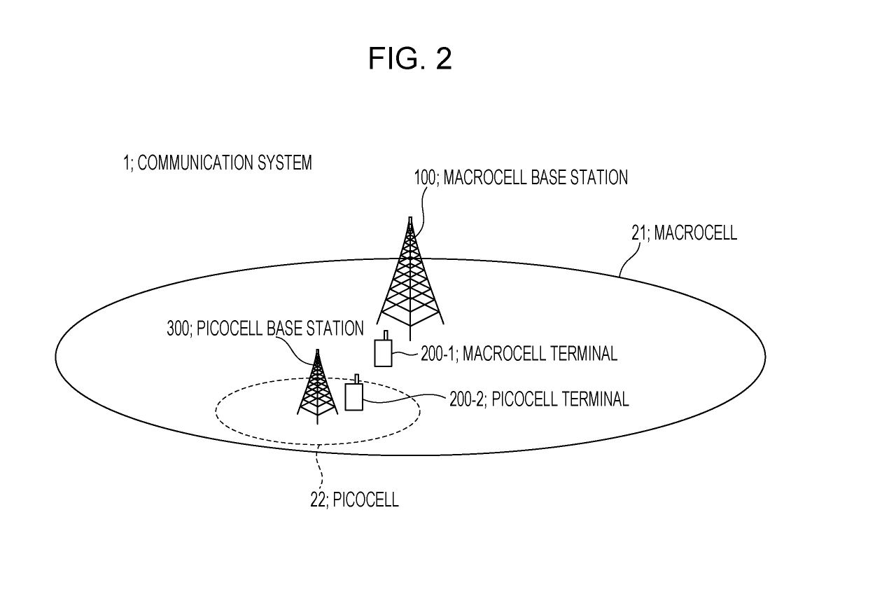

FIG. 2 illustrates a configuration example of a communication system 1 of a first embodiment. As illustrated in FIG. 2, a picocell 22 having a small coverage area is included in a macrocell 21 having a large coverage area. The base station in each cell is connected to a respective terminal. A macrocell terminal 200-1 is connected to a macrocell base station 100 (first base station apparatus), and a picocell terminal 200-2 is connected to a picocell base station 300.

The macrocell terminal 200-1 and the picocell terminal 200-2 may be collectively referred to as the terminal apparatus 200.

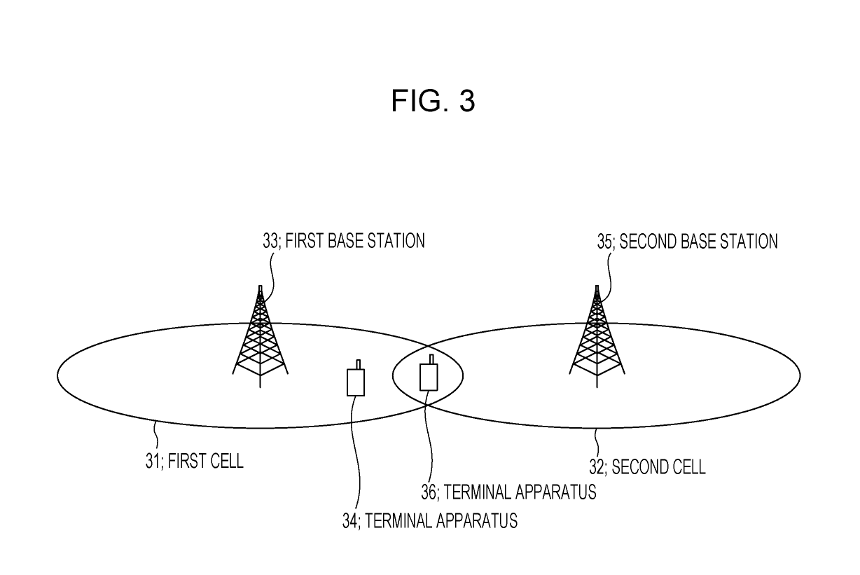

The present embodiment is assumed to be the communication system 1 of FIG. 2 as an example. The present embodiment is applicable to a multi-cell environment where inter-cell interference occurs. The present embodiment may also applicable to a cell or a zone including Remote Radio Equipment (RRE), a femtocell base station, and a relay station. The number of cells and the number of terminals are not limited to those described in the present embodiment. In the communication system, cells of the same type may partially overlap each other as illustrated in FIG. 3. This is applicable not only to the first embodiment, but also other embodiments.

FIG. 3 illustrates a configuration example of the communication system where cells of the same type partially overlap each other. As illustrated in FIG. 3, part of the communication area of a first cell 31 overlaps part of the communication area of the second cell 32. A terminal apparatus is connected to the base station of each cell. For example, a terminal apparatus 34 is connected to a first base station 33 and a terminal apparatus 36 is connected to a second base station 35.

In the present embodiment, the multiple base stations are connected to each other through a wired network, and share information. The multiple base stations may be connected to each other not through a wired network but through a radio network. In the case of a relay station, the relay station is connected to another base station through a radio network.

The femtocell base station exchanges information with the macrocell base station 100 via the Internet. The remote radio equipment and the picocell base station exchange information with the macrocell base station 100 via an optical fiber or an exclusive network. In LTE (Long Term Evolution) and LTE-A (LTE-Advanced), standardized in 3GPP, an interface called X2 serving as an interface between base stations is defined, and this interface may be used.

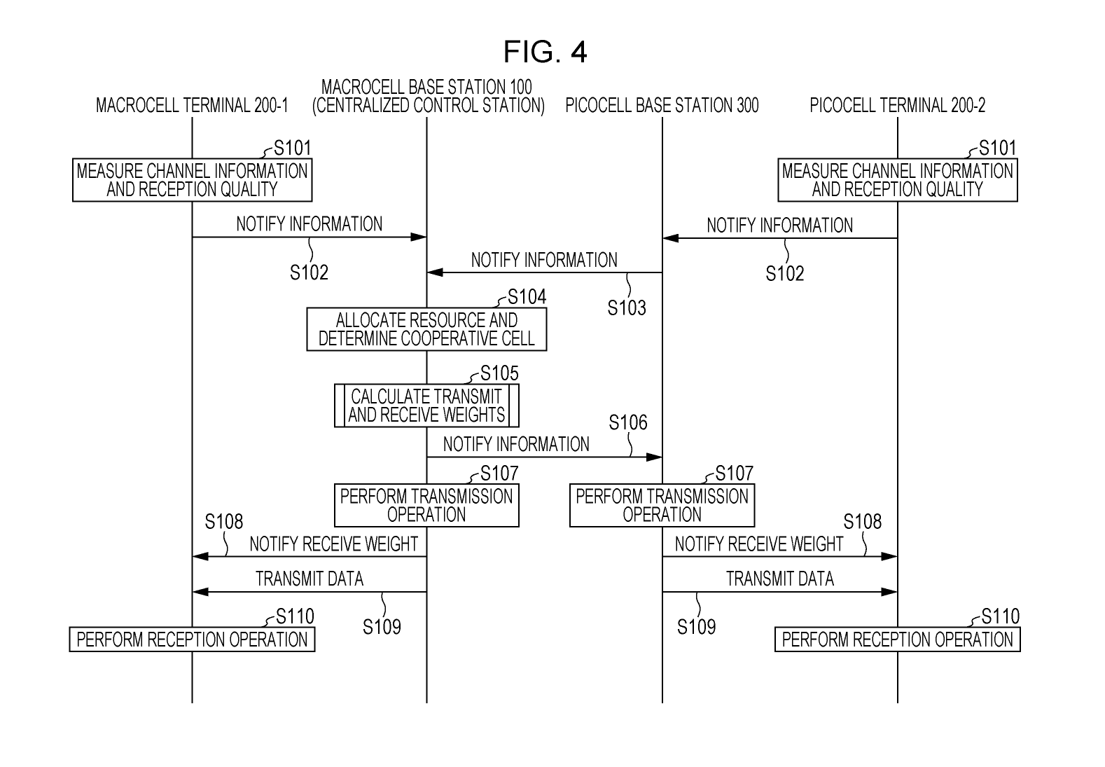

A process flow of the base station and the terminal apparatus of the present embodiment is described with reference to FIG. 4.

FIG. 4 is a flowchart illustrating an example of the process flow of the communication system of the first embodiment. In the present embodiment, a centralized control station (first base station apparatus) performs a process needed for the coordinated control. The macrocell base station 100 serves as the centralized control station, for example.

In step S101, each terminal (the macrocell terminal 200-1 and the picocell terminal 200-2) estimates a channel between the terminal and the base station connected thereto, and a channel between the terminal and an interfering station, and treats the estimated channels as channel information. In this case, each terminal estimates the channels using channel estimation reference signal under study by 3GPP (CRS: Cell Specific Reference Signal or CSI—RS: CSI—Reference Signal).

Each terminal measure reception quality from a synchronization signal and the like. The reception quality is a value included in elements related to interference (inter-cell interference), such as reception SINR (Signal to Interference plus Noise power Ratio), and may be measured from the reception level of the synchronization signal and the reference signals (CRS or CSI-RS). From the synchronization signal or the like, each terminal may acquire information of a cell that is an interference source.

In step S102, the macrocell terminal 200-1 and the picocell terminal 200-2 notify the base station respectively connected thereto of the channel information estimated and the reception quality measured in step S101.

In S103, the picocell base station 300 notifies the macrocell base station 100 of the information acquired in step S102 (the channel information and reception quality) via the wired network. If there are multiple base stations excluding the centralized control station, each base station other than the centralized control station performs the operation in step S103.

In S104, the macrocell base station 100 performs resource allocation based on the reception quality of each cell. Since it is known from the reception quality of each cell (information related to a cell that is an interfering source) that the macrocell and the picocell interferes with each other, the macrocell base station 100 treats the macro cell and the picocell as cooperative cells (target cells of the coordinated control), and allocates the same resource (frequency bandwidth) to the macrocell terminal 200-1 and the picocell terminal 200-2. For example, three resource blocks (RB1 through RB3) out of the six resource blocks of FIG. 1 are allocated to the cooperative cells.

In the present embodiment, the cells interfering with each other are set to be cooperative cells, and cells included in the cooperative cells are treated as a target of the coordinated control, and are allocated the same resource. In this way, inter-cell interference is suppressed between the cooperative cells through the coordinated control. Since the terminals connected to the base stations in these cells use the same resource, the frequency utilization efficiency is increased. The resource allocated to the cooperative cells may be a resource block presenting a high reception quality to the cooperative cells.

In the present embodiment, the cooperative cells and the resource allocation are determined based on the reception quality notified by the terminal. If these pieces of information are predetermined, the resource allocation may be performed in accordance with these pieces of information.

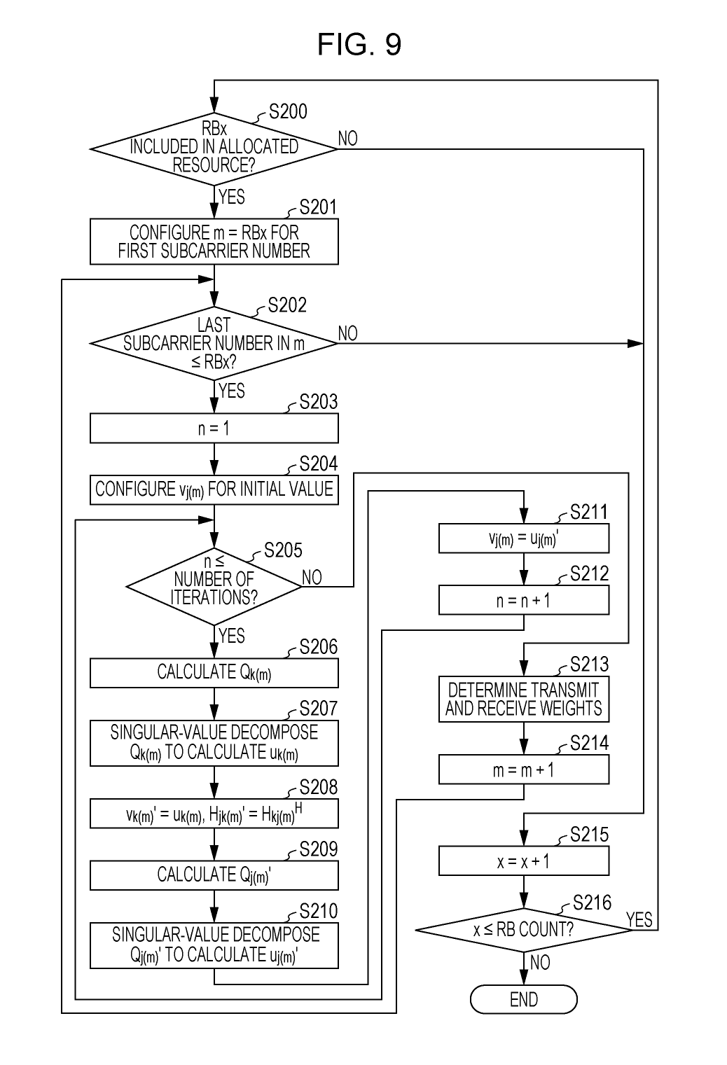

In step S105, the macrocell base station 100 calculates transmit and receive weights for the coordinated control in accordance with the channel information. The IA technique is used herein as an example of the coordinated control. Several methods are disclosed as the calculation method of calculating the transmit and receive weights to implement the IA technique. The macrocell base station 100 in the present embodiment uses a calculation method based on an iteration algorithm of FIG. 9 described below, for example.

In step S106, the macrocell base station 100 notifies the picocell base station 300 of the transmit and receive weights calculated in step S105 and the resource allocation via the wired network. The information notified to each cell is only information related to that cell. In the present embodiment, the information that the macrocell base station 100 notifies to the picocell base station 300 is a transmit weight v2, a receive weight u2, and resource allocation (information representing RB1 through RB3). The transmit weight v2, the receive weight u2, and the resource allocation are described in detail below. In the present embodiment, only one terminal is connected to the picocell base station 300, and the number of receive weights notified to the picocell base station 300 is one. If multiple terminals are connected to the picocell base station 300, the receives weights of the multiple terminals are notified.

If there are multiple base stations excluding the centralized control station, the centralized control station notifies each base station of the transmit and receive weights calculated for the base stations and the resource allocation.

In step S107, each base station performs a transmission operation based on the information notified in 5106.

In step S108, each base station notifies the terminal connected thereto of the receive weight.

In step S109, each base station transmits data to the terminal connected thereto.

In step S110, each terminal performs a reception operation by receiving a signal from the base station connected thereto. Each terminal estimates the channel information and the reception quality from the received information. The process of the flowchart is thus complete.

### <Base Station>

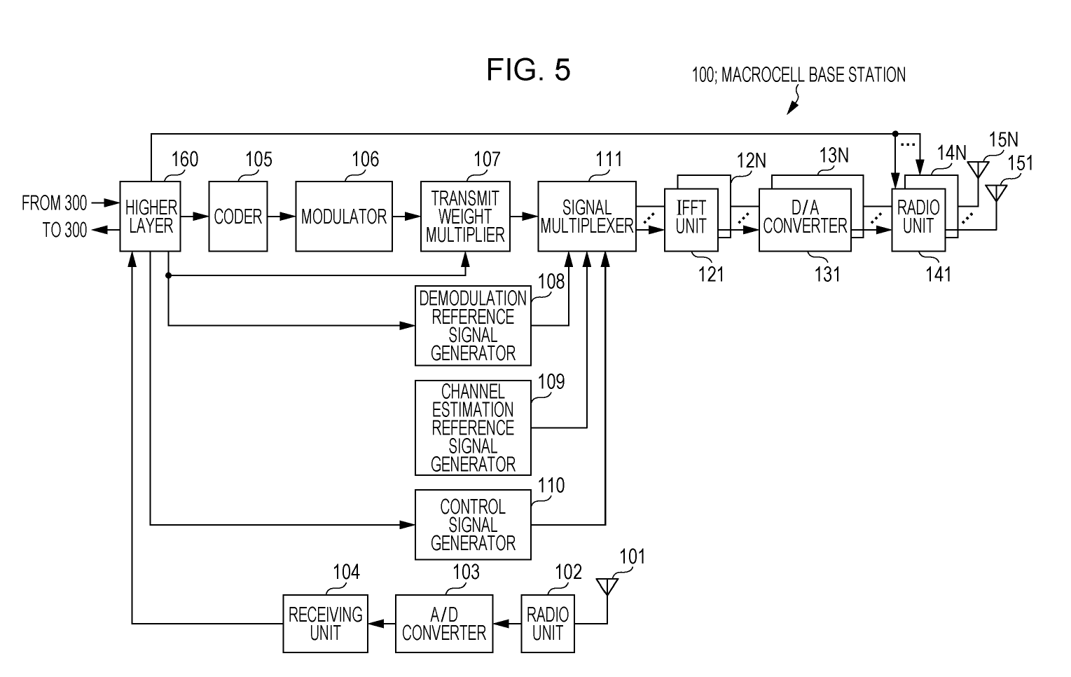

FIG. 5 is a block diagram diagrammatically illustrating the configuration of the macrocell base station 100 of the first embodiment.

The macrocell base station 100 includes a receive antenna 101, a radio unit 102, an A/D (Analog to Digital) converter 103, a receiving unit 104, a coder 105, a modulator 106, a transmit weight multiplier 107, a demodulation reference signal generator 108, a channel estimation reference signal generator 109, a control signal generator 110, a signal multiplexer 111, N IFFT units 12i (i is an integer within a range of 1 through N) including IFFT units 121, . . . , 12N (N is a positive integer), N D/A converters 13i (i is an integer within a range of 1 through N) including D/A converters 131, . . . , 13N (N is a positive integer), N radio units 14i (i is an integer within a range of 1 through N) including radio units (transmission units) 141, . . . , 14N (N is a positive integer), transmit antennas 15i (i is an integer within a range of 1 through N) including transmit antennas 151, . . . , 15N (N is a positive integer), and a higher layer 160.

The receive antenna 101 receives a signal transmitted from the terminal connected thereto, and outputs the reception signal to the radio unit 102.

The radio unit 102 downconverts the reception signal input from the receive antenna 101 to generate a baseband signal, and outputs the generated baseband signal to the A/D converter 103.

The A/D converter 103 converts an input analog signal into a digital signal, and outputs the digital signal as a result of conversion to the receiving unit 104.

The receiving unit 104 outputs to the higher layer the channel information estimated by the terminal and the reception quality measured by the terminal derived from the digital signal input from the A/D converter 103 (see step S102 of FIG. 4).

The higher layer 160 receives the channel information and the reception quality transmitted from the picocell base station 300 via the wired network. Based on the received channel information and reception quality, the higher layer 160 determines the cooperative cell, the resource allocation, and the transmit and receive weights of each of the subcarrier (see step S104 and step S105 of FIG. 4). The higher layer 160 further notifies the base station of the determined resource allocation and the transmit and receive weights of each subcarrier (see step S106 of FIG. 4).

The higher layer 160 outputs the determined resource allocation to the control signal generator 110. The higher layer 160 also outputs the determined transmit and receive weights of each subcarrier to the transmit weight multiplier 107 and the demodulation reference signal generator 108. The higher layer 160 further outputs the determined receive weight of each subcarrier to each radio unit 14i.

The coder 105 codes a transmission bit train string input from the higher layer, and outputs the coded transmission bit train to the modulator 106.

The modulator 106 modulates the transmission bit train coded and input by the coder 105 in accordance with a modulation scheme such as QPSK (Quadrature Phase Shift Keying) or 16QAM (Quadrature Amplitude Modulation), and outputs the modulated bit train to the transmit weight multiplier 107.

The transmit weight multiplier 107 multiplies the transmission bit train input from the modulator 106 by the transmit weight of each subcarrier input from the higher layer 160, and outputs a transmission data signal obtained through multiplication to the signal multiplexer 111. In order to perform spatial multiplexing, the transmit weight multiplier 107 parallelizes the transmission bit train by the number of space multiplexes in layer mapping of the related art, and multiplies the parallelized outputs by the transmit weight on a per subcarrier basis.

The demodulation reference signal generator 108 multiplies a known reference signal on each subcarrier by the transmit weight on each subcarrier to generate a demodulation reference signal, and outputs the generated demodulation subcarrier signal to the signal multiplexer 111.

The channel estimation reference signal generator 109 generates a known reference signal as a channel estimation reference signal, and outputs the generated reference signal to the signal multiplexer 111.

The control signal generator 110 generates control information to be notified to the terminal (information such as a resource allocation, a modulation scheme, and a coding rate), and outputs the generated control information to the signal multiplexer 111.

The signal multiplexer 111 multiplexes the transmission data signal input from the transmit weight multiplier 107 with the demodulation reference signal input from the demodulation reference signal generator 108, the channel estimation reference signal input from the channel estimation reference signal generator 109, and the control signal input from the control signal generator 110. The signal multiplexer 111 outputs the transmission signal obtained as a result of multiplexing to the IFFT units 121, . . . , 12N.

Each IFFT unit 12i transforms the input transmission signal in the frequency domain into a signal in the time domain in accordance with IFFT (Inverse Fast Fourier Transform), and adds a guard interval (GI) to the resulting signal. The IFFT unit 12i then outputs the signal in the time domain to the D/A converter 13i of the same index i.

Each D/A converter 13i converts the signal input from the IFFT unit 12i as a digital signal into an analog signal, and outputs the resulting analog signal to the radio unit 14i of the same index i.

Each radio unit 14i quantizes the receive weight input from the higher layer 160, thereby converting the receive weight into a signal appropriate for data communications.

Each radio unit 14i upconverts the signal obtained a result of the conversion to a radio frequency signal, and then transmits the upconverted signal to the macrocell terminal 200-1 via the corresponding transmit antenna 15i (see step S108 of FIG. 4). Note that each radio unit 14i in the present embodiment is configured to transmit separately the receive weight and the control signal, but the receive weight may be multiplexed with the control signal for transmission.

Each radio unit 14i further upconverts the analog signal input from the corresponding D/A converter 13i into a radio frequency signal, and then transmits the radio signal to the macrocell terminal 200-1 via the corresponding transmit antenna 15i (see step S109 of FIG. 4).

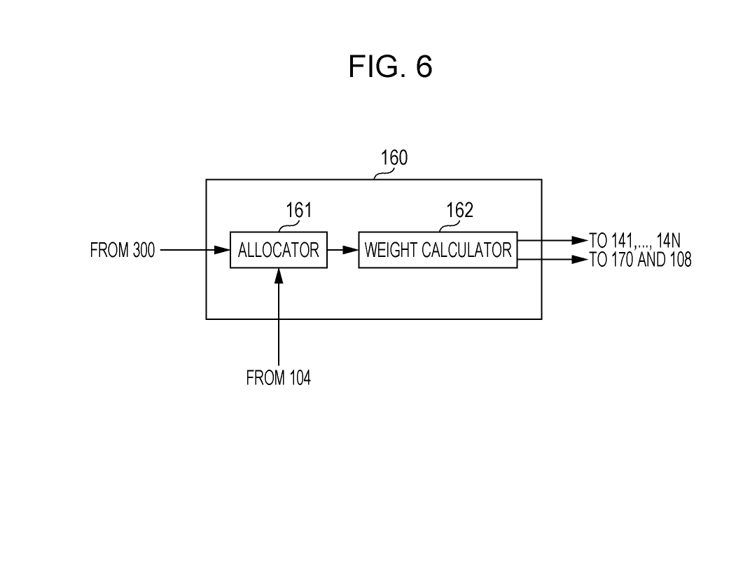

FIG. 6 is a block diagram illustrating the configuration of the higher layer 160 of the first embodiment. The higher layer 160 includes an allocator 161 and a weight calculator 162.

The allocator 161 receives the reception quality of the picocell 22 transmitted from the picocell base station 300. The allocator 161 also receives the reception quality of the macrocell 21 transferred from the receiving unit 104.

The allocator 161 allocates a frequency bandwidth for use in communications based on the reception quality of each cell (such as the macrocell 21 or the picocell 22). More specifically, the allocator 161 determines from the reception quality of each cell (information related to a cell as an interference source) whether the macrocell and the picocell interfere with each other. If the macrocell and the picocell interfere with each other as illustrated in FIG. 2, the allocator 161 determines that the cooperative cells (cells as the target of the coordinated control) are the macrocell 21 and the picocell 22, and allocates the same resource (frequency bandwidth) to the macrocell terminal 200-1 and the picocell terminal 200-2.

On the other hand, if the macrocell and the picocell do not interfere with each other, the allocator 161 allocates to the macrocell terminal 200-1 and the picocell terminal 200-2 frequency bandwidths having the best channel characteristics. The allocator 161 then outputs the allocation results to the weight calculator 162.

If the allocation results input from the allocator 161 indicate the same frequency band allocation, the weight calculator 162 calculates the transmit weight and the receive weight in accordance with which the terminals having the same frequency allocated by the allocator 161 perform the coordinated control. The calculation method of the transmit weight and receive weight is described in detail below.

The weight calculator 162 outputs the transmit and receive weights to the transmit weight multiplier 107 and the demodulation reference signal generator 108. Also, the weight calculator 162 outputs the calculated receive weight to the radio units 141, . . . , 14N.

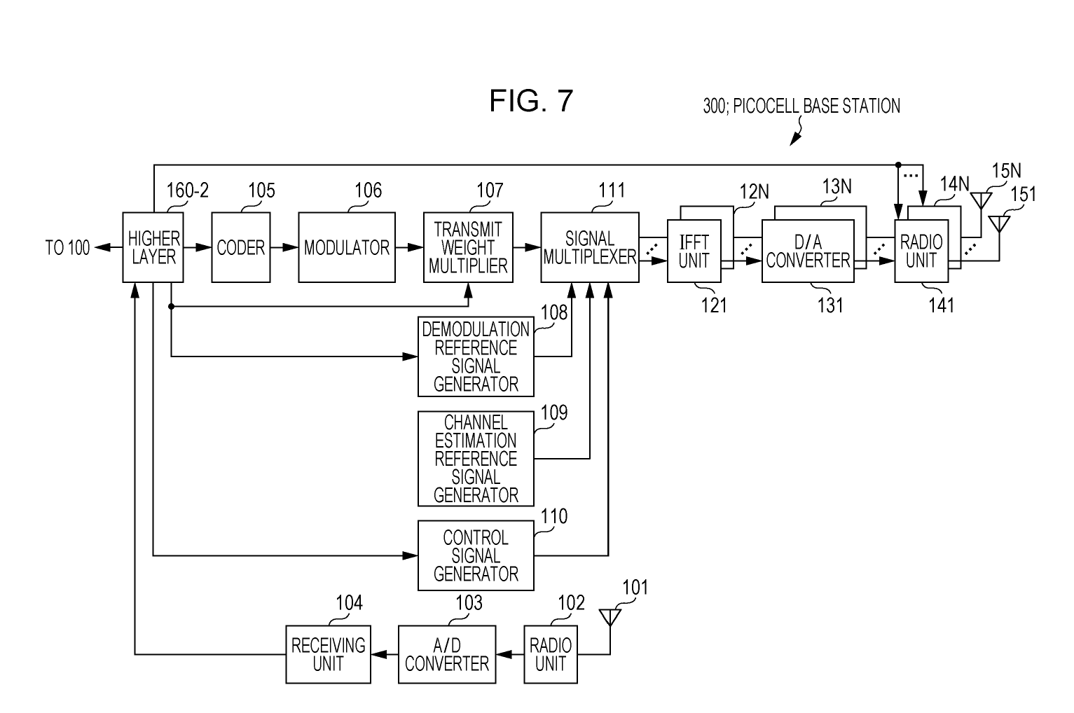

FIG. 7 is a block diagram diagrammatically illustrating the configuration of the picocell base station 300 of the first embodiment.

Elements identical to those illustrated in FIG. 5 are designated with the same reference numerals and the specific discussion thereof is omitted herein. The configuration of the picocell base station 300 of FIG. 7 is different from the configuration of the macrocell base station 100 of FIG. 5 in that the picocell base station 300 includes a higher layer 160-2 modified from the higher layer 160.

The higher layer 160-2 notifies the macrocell base station 100 of the channel information and reception quality of each cell via the wired network (see step S103 of FIG. 4).

The higher layer 160-2 receives the resource allocation and the transmit and receive weights from the macrocell base station 100. The higher layer 160-2 outputs the received resource allocation to the control signal generator 110. The higher layer 160-2 also outputs the received transmit weight on each subcarrier to the transmit weight multiplier 107 and the demodulation reference signal generator 108.

### <Terminal>

The macrocell terminal 200-1 and the picocell terminal 200-2 are described below. The macrocell terminal 200-1 and the picocell terminal 200-2 are collectively referred to as a terminal apparatus 200.

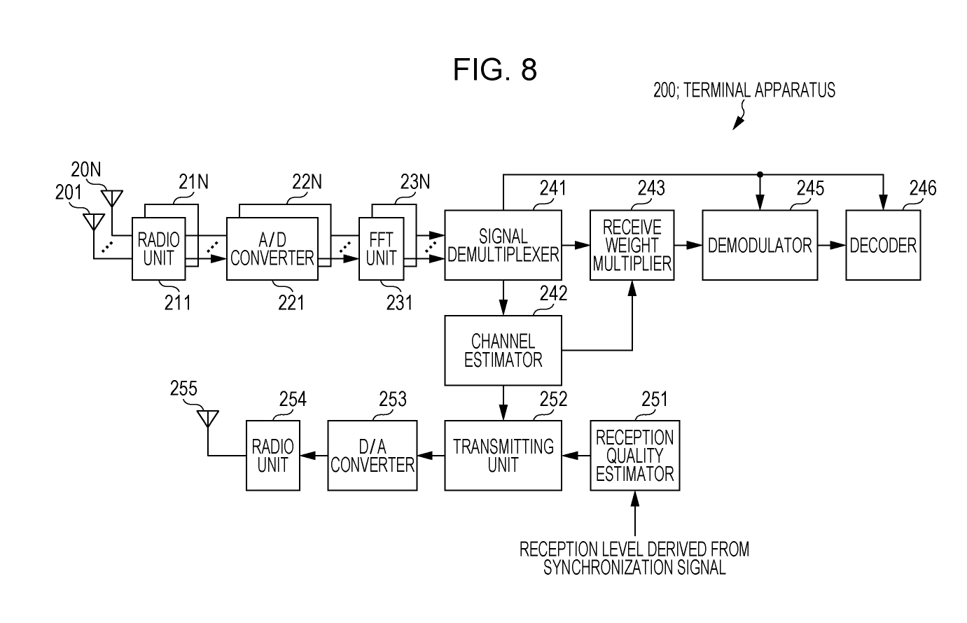

FIG. 8 is a block diagram diagrammatically illustrating the configuration of the terminal apparatus 200 of the first embodiment.

The terminal apparatus 200 includes receive antennas 201, . . . , and 20N, radio units 211, . . . , and 21N, A/D converters 221, . . . , and 22N, FFT units 231, . . . , and 23N, a signal demultiplexer 241, a channel estimator 242, a receive weight multiplier 243, a demodulator 245, a decoder 246, a reception quality estimator 251, a transmitting unit 252, a D/A converter 253, a radio unit 254, and a transmit antenna 255.

The receive antenna 20i receives a signal including the receive weight transmitted from the base station connected to a host terminal (see step S108 of FIG. 4). The receive antenna 20i receives from the base station connected to the host terminal a signal including the reference signals (the demodulation reference signal and the channel estimation reference signal), the control information, and the reception data signal.

Each receive antenna 20i outputs the above-described signals received from the base station connected to the host terminal to the radio unit 21i of the same index i.

Each radio unit 21i downconverts the received signal input from the receive antenna 20i to generate a baseband signal, and outputs the generated baseband signal to the A/D converters 221, . . . , and 22N.

Each A/D converter 22i converts the input analog signal into a digital signal, and outputs the resulting digital signal to the FFT unit 23i of the same index i.

Each FFT unit 23i transforms the digital signal input from the A/D converter 22i into a signal in the frequency domain in accordance with FFT (Fast Fourier Transform), and outputs the transformed signal to the signal demultiplexer 241.

The signal demultiplexer 241 demultiplexes the signal input from each FFT unit 23i into the reference signals (the demodulation reference signal and the channel estimation reference signal) and the control signal, and outputs the reference signals to the channel estimator 242 and the reception data signal and the receive weight to the receive weight multiplier 243. The signal demultiplexer 241 outputs the demultiplexed control information to the receive weight multiplier 243, the demodulator 245, and the decoder 246.

The receive weight multiplier 243 multiplies the reception data signal input from the signal demultiplexer 241 by the receive weight input from the signal demultiplexer 241, and outputs the signal obtained as a result of multiplication to the demodulator 245. In this case, the receive weight multiplier 243 references the control information (the resource allocation) and multiplies the reception data signals in the subcarriers in RB1 through RB3 used by each terminal by the receive weights of the respective subcarriers.

The demodulator 245 demodulates the input reception data signal in accordance with the control information (the modulation scheme) input from the signal demultiplexer 241, and outputs the resulting received bit train to the decoder 246.

The decoder 246 decodes the received bit train input from the demodulator 245 in accordance with the control information input from the signal demultiplexer 241 (coding rate), thereby resulting in a decoded bit train.

The channel estimator 242 estimates the channel information of each subcarrier from the channel estimation reference signal included in the reference signals input from the signal demultiplexer 241, and outputs the estimated channel information to the transmitting unit 252. The channel estimator 242 estimates equivalent channel information of each subcarrier from the demodulation reference signal included in the reference signals, and outputs the estimated equivalent channel information to the receive weight multiplier 243. The equivalent channel information indicates an equivalent channel accounting for the transmit weight to be multiplied in the base station, and the demodulation reference signal generator generates a demodulation reference signal accounting for the transmit weight. By receiving this signal, the equivalent channel is obtained.

In the present embodiment, the macrocell base station 100 calculates the receive weight and notifies each terminal of the receive weight. With this arrangement, each terminal is free from calculating the receive weight.

However, if each terminal calculates the receive weight, a known signal (the demodulation reference signal) as a result of multiplication by the transmit weight is transmitted so that each terminal may estimate the equivalent channel information. The notification of the receive weight is not necessarily performed. Each terminal may be configured to estimate the equivalent channel information. Even if the receive weight is notified, each terminal may calculate the receive weight.

The reception quality estimator 251 receives the synchronization signal from each base station in a peripheral cell, and estimates the reception quality from the reception level obtained from the synchronization signal. If the reception level is higher than a specific threshold value, the reception quality estimator 251 determines that a base station having transmitted the synchronization signal from which the reception level is obtained is an interfering station. The reception quality estimator 251 outputs to the transmitting unit 252 the estimated reception quality (a value included in elements related to interference and information of the cell as the interference source).

The transmitting unit 252 converts the channel information input from the channel estimator 242, and the reception quality input from the reception quality estimator 251 into a transmission signal in a transmitable form, and outputs the converted transmission signal to the D/A converter 253.

The D/A converter 253 converts the digital transmission signal input from the transmitting unit 252 into an analog signal, and outputs the converted analog signal to the radio unit 254.

The radio unit 254 transmits via the transmit antenna 255 the analog signal input from the D/A converter 253 to the base station connected to the host terminal.

In the present embodiment, the reception quality estimator 251 estimates the reception quality in response to the synchronization signal that each cell has received from the adjacent cell. The present embodiment is not limited to this method. The reception quality estimator 251 may estimate the reception quality based on information exchanged between the base stations.

For example, in LTE system, the reception quality estimator 251 may estimate the reception quality using the control information such as RNTP (Relative Narrowband Tx Power). RNTP helps know whether the transmission power of each base station among the base stations is high or low on a per resource block basis. Since RNTP is information indicating the transmission power of each cell on a per resource block basis, the transmission power of each cell is known by referencing this information at each base station. The reception quality estimator 251 may thus determine that a cell having a low transmission power value is a cell not interfering with an adjacent cell, and that a cell having a high transmission power value is a cell interfering with an adjacent cell.

If the positional relationship of each cell is known in advance, the reception quality estimator 251 may estimate the reception quality of each resource block by accounting for the positional relationship and RNTP.

### <Detail of Calculation of Transmit and Receive Weights>

The calculation operation of the transmit and receive weights performed by the weight calculator 162 is described below.

Variables introduced in the following operations are described below. NBS represents the number of base stations as targets of the coordinated control, and NUE represents the number of terminals as targets of the coordinated control. Also, j (1≦j≦NBS) represents the identification number of a base station, and k (1≦k≦NUE) represents the identification number of a terminal. In the present embodiment, j=1 represents the macrocell base station 100, j=2 represents the picocell base station 300, k=1 represents the macrocell terminal 200-1, and k=2 represents the picocell terminal 200-2. Hkj(m) represents the channel information between a j-th base station (1≦j≦NBS) and a k-th terminal (1≦k≦NUE) at an m-th subcarrier. Hjk(m)′ represents the channel information between the k-th terminal (1≦k≦NUE) and the j-th base station (1≦j≦NBS) at the m-th subcarrier. Also, v represents the transmit weight, u represents the receive weight, and Q represents a covariance matrix of a received interfering signal. P represents a transmission power, and d represents the number of streams to be transmitted.

Also, x represents a resource block number (1≦x≦resource block count (6 in the present embodiment)), and m represents a subcarrier number (1≦m≦the last subcarrier number within a communication frame (72 in the present embodiment). Any number may be configured to be the number of iterations. Given a larger number of iterations, the transmit and receive weights suppressing the effect of inter-cell interference more are calculated.

FIG. 9 is a flowchart illustrating a flow of a calculation process of transmit and receive weighs in step S105 of FIG. 4.

In step S200, the weight calculator 162 determines whether RBx is included in the resource allocation. More specifically, in the present embodiment, the weight calculator 162 determines from x=1, 2, and 3 that RBx is included in the resource allocation, and determines from x=4, 5, and 6 that RBx is not included in the resource allocation.

In step S201, the weight calculator 162 (FIG. 6) configures the subcarrier number m to be the first subcarrier number in RBx. More specifically, the weight calculator 162 specifies the first subcarrier number of each resource block, for example, if the resource block number x is 1, the subcarrier number m is 1, and if the resource block number x is 2, the subcarrier number m is 13.

In step S202, the weight calculator 162 makes a determination to iterate operations in steps S203 through S214 while the subcarrier number m is equal to or below the last subcarrier number in RBx. More specifically, the weight calculator 162 determines whether the subcarrier number m is equal to or below the last subcarrier number in RBx. If the subcarrier number m is equal to or below the last subcarrier number in RBx (yes branch from step S202), the weight calculator 162 proceeds to step S203. If the subcarrier number m is above the last subcarrier number in RBx (no branch from step S202), the weight calculator 162 proceeds to step S215.

In step S203, the weight calculator 162 initializes the index n to 1.

In step S204, the weight calculator 162 configures the transmit weight vj(m) to be any initial value.

In step S205, the weight calculator 162 makes a determination to iterate operations in steps S205 through S212 while the index number is equal to or below the predetermined number of iterations. More specifically, the weight calculator 162 determines whether the index number n is equal to or below the number of iterations. If the index number n is equal to or below the number of iterations (yes branch from step S205), the weight calculator 162 proceeds to step S206. If the index number is above the number of iteration (no branch from step S205), the weight calculator 162 proceeds to step S213.

In step S206, the weight calculator 162 calculates covariance matrix Qk(m) of interference based on the channel information and the transmit weight. More specifically, the weight calculator 162 calculates the covariance matrix Qk(m) in accordance with the following Formula (1).

$$\begin{matrix}[ Math . 1 ] & \\ {Q}_{k ( m )} = {\sum }_{j = 1 , j \neq k}^{{N}_{BS}} \frac{{P}_{j ( m )}}{{d}_{j ( m )}} {H}_{kj ( m )} {v}_{j ( m )} {v}_{j ( m )}^{H} {H}_{kj ( m )}^{H} & ( 1 )\end{matrix}$$

In Formula (1), superscript H represents a complex conjugate transposed matrix. The weight calculator 162 calculates the receive weight based on the calculated covariance matrix Qk(m) of interference. More specifically, in step S207, the weight calculator 162 singular-value decomposes the covariance matrix Qk(m) of interference to calculate a receive weight uk(m). Left singular vectors, obtained as a result of the singular value decomposition of the covariance matrix Qk(m), corresponding to a smaller singular value, are selected by a stream count and treated as the receive weight uk(m). More specifically, the weight calculator 162 extracts, from the left singular vectors (receive antenna count rows and receive antenna count columns), columns equal to the stream count from the left and treats the columns as the receive weight uk(m).

In step S208, the weight calculator 162 substitutes the calculated value of the receive weight uk(m) for a transmit weight vk(m)′, and substitutes a value Hkj(m)H for channel information Hjk(m)′.

In step S209, the weight calculator 162 calculates a covariance matrix Qj(m)′ of interference based on the channel information and the receive weight. More specifically, the weight calculator 162 calculates the covariance matrix Qj(m)′ in accordance with the following Formula (2).

$$\begin{matrix}[ Math . 2 ] & \\ {Q}_{{j ( m )}^{′}} = {\sum }_{k = 1 , k \neq j}^{{N}_{UE}} \frac{{P}_{k ( m )}^{′}}{{d}_{k ( m )}} {H}_{jk ( m )}^{′} {v}_{k ( m )}^{′} {{v}^{′}}_{j ( m )}^{H} {{H}^{′}}_{jk ( m )}^{H} & ( 2 )\end{matrix}$$

The weight calculator 162 calculates the transmit weight based on the calculated covariance matrix Qj(m)′ of interference. More specifically, in step S210, the weight calculator 162 singular-value decomposes the covariance matrix Qj(m)′ to calculate a receive weight uj(m)′. As in step S207, the weight calculator 162 selects left singular vectors, obtained as a result of the singular value decomposition of the covariance matrix Qj(m)′, corresponding to a smaller singular value, by a stream count and treats as the receive weight uj(m)′. More specifically, the weight calculator 162 extracts, from the left singular vectors (transmit antenna count rows and transmit antenna count columns), columns equal to the stream count from the left and treats the columns as the receive weight uj(m)′.

In step S211, the weight calculator 162 substitutes the calculated receive weight uj(m)′ for a transmit weight vj(m).

In step S212, the weight calculator 162 adds 1 to the index n and proceeds to step S204. In step S204, the weight calculator 162 compares the value of the index n with the number of iterations, and iterates operations in steps S205 through S212 by a predetermined number of iterations. If the index n is above the predetermined number of iterations (no branch from step S205), the weight calculator 162 proceeds to step S213.

In step S213, the weight calculator 162 configures a transmit weight of the m-th subcarrier to be the obtained vj(m) and configures a receive weight of the m-th subcarrier to be the complex conjugate transposed vector uk(m)H of the receive weight uk(m).

In step S214, the weight calculator 162 adds 1 to the subcarrier number m and returns to step S202. The weight calculator 162 iterates operations in step S203 through S213 by the subcarrier count of RBX. If the subcarrier number m is above the last subcarrier number in RBx (no branch from step S202), the weight calculator 162 proceeds to step S215.

In step S215, the weight calculator 162 adds 1 to the resource block number x and proceeds to step S216.

In step S216, the weight calculator 162 determines whether the resource block number x is equal to or below the resource block count (RB count, 6 in the present embodiment). If the resource block number x is equal to below the RB count (yes branch from step S216), the weight calculator 162 returns to step S200, and performs the process for the next resource block.

The weight calculator 162 iterates the above-described process by the resource block count. If the resource block number x is above the RB count (no branch from step S216), the weight calculator 162 ends the process. The process of the flowchart has been described.

The weight calculator 162 calculates the transmit and receive weights on each of all subcarriers included in the resource allocation (in the present embodiment, all subcarriers included in RB1 through RB3).

In the algorithm of FIG. 9, the weight calculator 162 updates the weight repeatedly so that a weight corresponding to a smaller singular value (a weight decreasing interfering power) is used. For this reason, after the predetermined number of iterations, the weight calculator 162 may obtain the transmit and receive weights that suppress the effect of interference. The communication system 1 of the present embodiment uses the transmit and receive weights thus obtained, and multiple cells suppress the effect of interference in concert with each other. The algorithm has been discussed for exemplary purposes, and another algorithm may also be used.

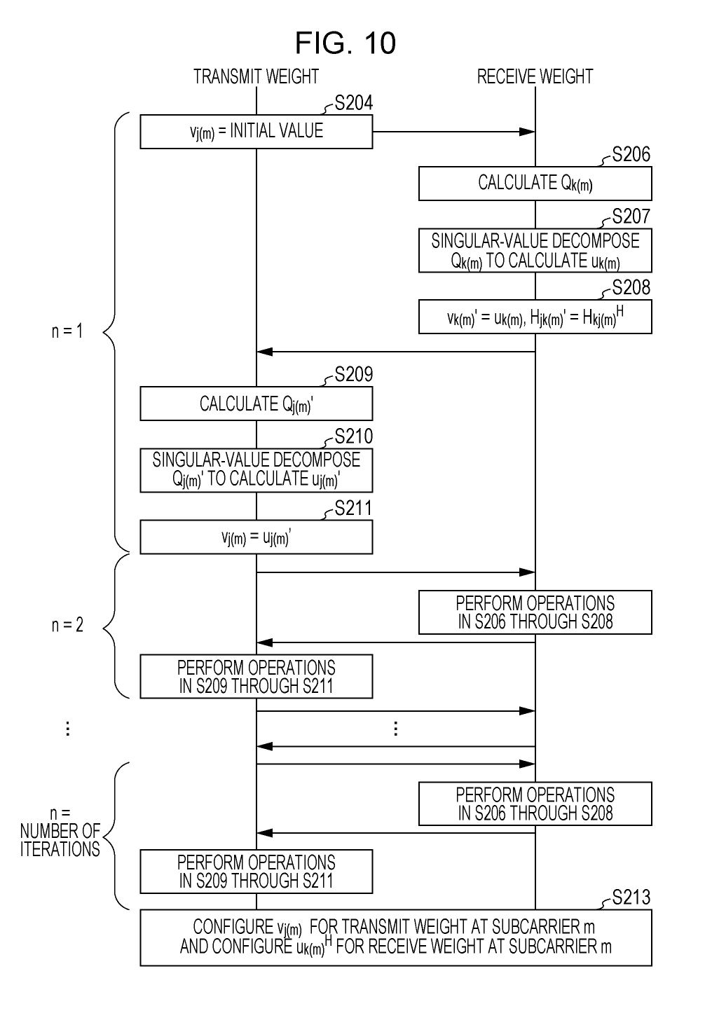

FIG. 10 illustrates a calculation process of FIG. 9 to calculate the transmit weight and receive weights. As illustrated in FIG. 10, the calculation process is divided into a calculation process of the transmit weight and a calculation process of the receive weight.

With the index n being 1, the weight calculator 162 substitutes an initial value for the transmit weight vj(m) (step S204). The weight calculator 162 calculates the covariance matrix Qk(m) (step S205). The weight calculator 162 singular-value decomposes the covariance matrix Qk(m) to calculate the receive weight uk(m) (step S207).

The weight calculator 162 substitutes the value of the calculated receive weight uk(m) for the transmit weight vk(m)′ and substitutes the value of Hkj(m)H for the channel information Hjk(m)′ (step S208).

The weight calculator 162 calculates the covariance matrix Qj(m)′ of interference (step S209). The weight calculator 162 singular-value decomposes the covariance matrix Qj(m)′ of interference to calculate the receive weight uj(m)′ (step S210). The weight calculator 162 substitutes the calculated receive weight uj(m)′ for the transmit weight vj(m) (step S211).

With the index n being 2, the weight calculator 162 performs operations in steps S206 through S208, thereby updating the receive weight uk(m). The weight calculator 162 performs operations in steps S209 through S211, thereby updating the transmit weight vj(m). Similarly, the weight calculator 162 updates the receive weight uk(m) and the transmit weight vj(m) until the index n becomes 3 to n−1.

With the index n being the number of iterations, the weight calculator 162 performs operations in steps S206 through S208, thereby updating the receive weight uk(m). The weight calculator 162 performs operations in steps S209 through S211, thereby updating the transmit weight vj(m).

The weight calculator 162 configures the transmit weight at the m-th subcarrier to be the resulting transmit weight vj(m), and configures the receive weight at the m-th subcarrier to be the resulting receive weight uk(m). The weight calculator 162 thus calculates the transmit weight vj(m) and the receive weight uk(m) in this way.

The weight calculator 162 may use the coordinated transmission beam forming technique and the weight calculator 162 may calculate the transmit weight vk(m) of a base station in a cell j (1≦j≦NBS) using the channel information as expressed by the following Formula (3).

[Math. 3]

vⱼ₍ₘ₎=(Hⱼ₍ₘ₎^{H}Hⱼ₍ₘ₎)⁻¹Hⱼ₍ₘ₎

Hⱼ₍ₘ₎=[H₁ⱼ₍ₘ₎H₂ⱼ₍ₘ₎ . . . H_{N}_{_{UE}}ⱼ₍ₘ₎]^{H} (3)

In Formula (3), ZF (Zero Forcing) type transmit weight is used. Another transmit weight may be used.

### Advantageous Effect of First Embodiment

If three resource blocks are allocated to each cell in the related art technique, a total of six resource blocks is needed. This is because an adjustment is performed for the resource allocations not to be duplicated on the cells in view of the effect of inter-cell interference. In the present embodiment, the same resource may be allocated to the macrocell and picocell because the coordinated control minimizes inter-cell interference. In the present embodiment, three resource blocks are needed. The communication system of the first embodiment is free from the need to change to another resource to avoid inter-cell interference in a case that the same resource is allocated to multiple cells in a multi-cell environment. The frequency utilization efficiency is thus improved.

In the related art, the base station configures the terminals having duplicate resource allocations to have another resource to avoid inter-cell interference. For this reason, optimum scheduling of all the terminals is difficult to make, and some terminals are subject to throughput degradation.

In accordance with the present embodiment, the macrocell base station allocates the same resource to multiple cells, and minimizes the inter-cell interference through the coordinated control. The terminals thus enjoy excellent throughput.

In the multi-cell environment, the communication system of the first embodiment thus provides excellent throughput while improving the frequency utilization efficiency.

### Second Embodiment

In the first embodiment, the coordinated control is performed using the transmit and receive weights calculated on each subcarrier. In the present embodiment, however, a single set of transmit and receive weights is used on multiple carriers. The configuration of the second embodiment is described only in terms of a difference from the first embodiment. The number of subcarriers to calculate a set of transmit and receive weights is defined as a weight unit. For example, in the present embodiment, the weight unit is configured to be on one resource block (12 subcarriers in the example of FIG. 1). In the present embodiment, the terminal determines the weight unit. Alternatively, the base station may determine the weight unit. The system may also determine the weight unit.

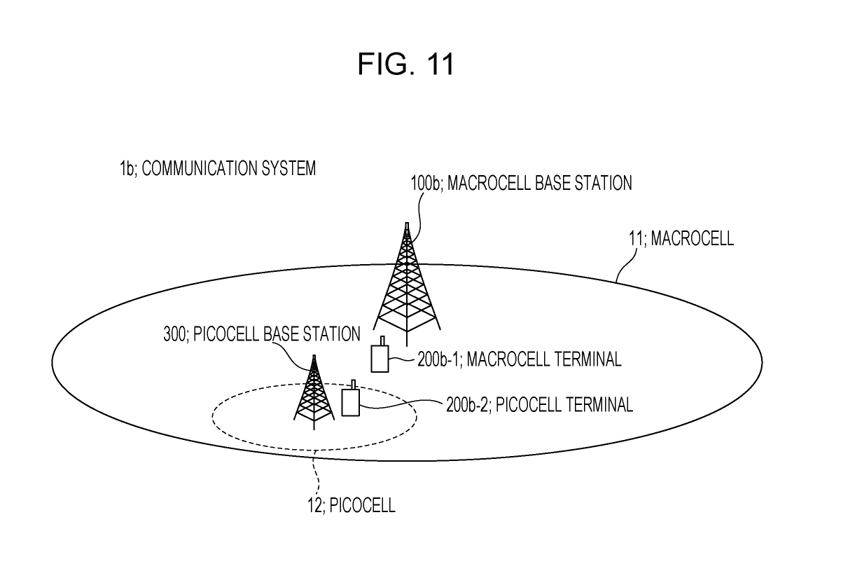

FIG. 11 illustrates the configuration of a communication system 1b of the second embodiment.

Elements identical to those illustrated in FIG. 2 are designated with the same reference numerals and the specific discussion thereof is omitted herein.

The configuration of the communication system 1b of FIG. 11 is different from the configuration of the communication system 1 of FIG. 2 in that the macrocell base station 100 is replaced with a macrocell base station (first base station apparatus) 100b, that the macrocell terminal 200-1 is replaced with the macrocell terminal 200b-1, and that the picocell terminal 200b-2 is replaced with the picocell terminal 200b-2. Also, the macrocell 11 is changed to a macrocell 21, and the picocell 12 is changed to a picocell 22.

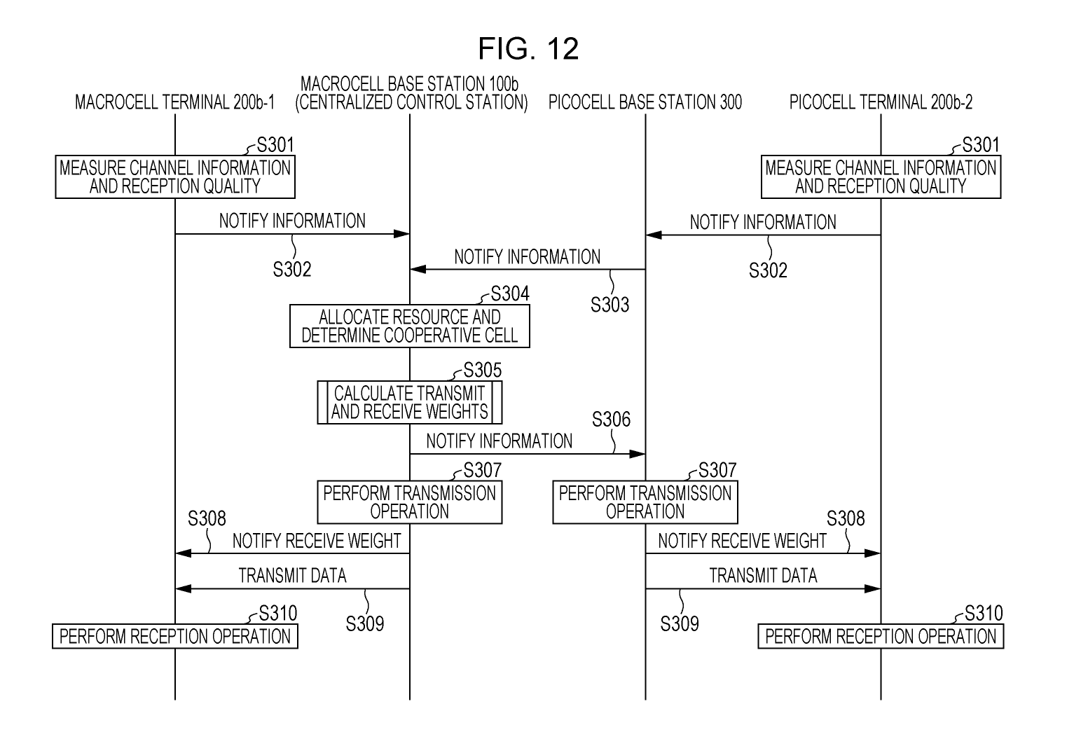

FIG. 12 is a flowchart illustrating a process flow of the communication system of the second embodiment. Steps S301, S307, S309, and step S310 are respectively identical to steps S101, S107, S109, and step S110 of FIG. 4, and the discussion thereof is omitted herein. The difference from the first embodiment is described with reference to FIG. 12.

In step S302, the terminals (the macrocell terminal 200b-1 and the picocell terminal 200b-2) notify the base station respectively connected thereto of the channel information and reception quality on each specified weight unit. In the second embodiment, the weight unit is one resource block, for example. The channel information and reception quality are single values on a per resource block basis (hereinafter referred to as representative values). In the second embodiment, a feedback count of each piece of information is six. Each terminal may calculate the mean value of the channel information on each weight unit as a representative value of the channel information, or may treat the channel information of one subcarrier of the subcarriers having the reference signals allocated thereto as a representative value of the channel information. Each terminal may calculate the mean value of the reception qualities on each weight unit as a representative value of the reception quality, or may treat the reception quality of one subcarrier of the subcarriers having the reference signals allocated thereto as a representative value of the reception quality. In the feedback operation of the representative value of the channel information or the reception quality, the representative value determined by the terminal may be fed back, or different information, such as a codebook, or a value of compressed information, may be fed back. The weight unit may be the same on the terminals, or may be different from terminal to terminal. More in detail, among multiple terminals, at least one terminal is different in weight unit from the other terminals. If the weight unit is the same on the terminals, an amount of information used to notify the terminals of the weight unit is reduced. Transmission efficiency is thus improved. On the other hand, if the weight unit is different from terminal to terminal, weight may be calculated in a unit appropriate for each terminal. Transmission performance is thus improved.

Each terminal in the first embodiment notifies the base station connected thereto of the channel information and reception quality of all the subcarriers. In the second embodiment, in contrast, each terminal notifies the base station connected thereto of a single piece of channel information and a single piece of information of reception quality on a specified weight unit. An amount of communication (an amount of feedback) from each terminal to the base station is reduced. In step S302, each terminal notifies the base station connected thereto of the weight unit.

In step S303, the picocell base station 300 notifies the macrocell base station 100b of information acquired in step S302 via the wired network. If there are multiple base stations excluding the centralized control station, these base stations perform the operation in step S303. In response to the notification of the representative value of the channel information from the picocell terminal 200b-2, the picocell base station 300 performs the following operation. The picocell base station 300 that is a base station apparatus other than the macrocell base station 100b may notify, via the wired network or the radio network, the macrocell base station 100b of the information representing the representative value of the channel information notified by the picocell terminal 200b-2.

In step S304, the macrocell base station 100b determines the resource allocation based on the reception quality on each weight unit notified by each terminal. The resource allocation in the present embodiment is RB1 through RB3 in the same manner as in the first embodiment.

In step S305, the macrocell base station 100b calculates the transmit and receive weights on each weight unit. In the first embodiment, the transmit and receive weights are calculated of the allocated resources (RB1 through RB3) on each subcarrier. In the present embodiment, in contrast, the transmit and receive weights of the allocated resources (RB1 through RB3) are calculated on each weight unit based on six pieces of the channel information fed back from each terminal. In the present embodiment, the macrocell base station 100b calculates three transmit and receive weights, for example. In a case that the terminal calculates the representative value of the channel information of the weight unit using the reference signal in step S302, the macrocell base station 100b may calculate the transmit weight or the receive weight on each weight unit using the representative value of the channel information. Alternatively, the macrocell base station 100b may calculate the transmit weight or the receive weight on each unit different from the weight unit using the representative value of the channel information.

The number of transmit and receive weights notified in step S306 and the number of the receive weights notified in step S308 are respectively three.

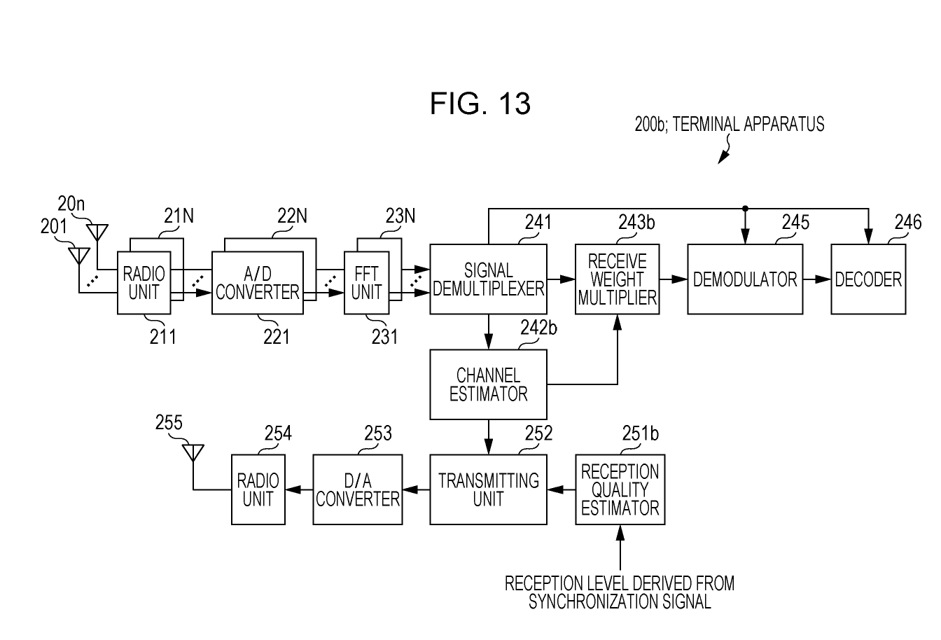

FIG. 13 is a block diagram diagrammatically illustrating the terminal apparatus 200b of the second embodiment.

Elements identical to those in FIG. 8 are designated with the same reference numerals and the specific discussion thereof is omitted herein. The configuration of the terminal apparatus 200b of FIG. 13 is different from the configuration of the terminal apparatus 200 of FIG. 8 in that the receive weight multiplier 243 is replaced with a receive weight multiplier 243b, that the channel estimator 242 is replaced with a channel estimator 242b, and that the reception quality estimator 251 is replaced with a reception quality estimator 251b.

The receive weight multiplier 243b has the same function as that of the receive weight multiplier 243 of the first embodiment, but is different from the receive weight multiplier 243 in the following point.

The receive weight multiplier 243b multiples the reception data signal input from the signal demultiplexer 241 by the same receive weight on each weight unit. More specifically, in an example of the present embodiment, the receive weight multiplier 243b multiples the reception data signal by the receive weight of w=1 in a subcarrier of the resource block 1, multiples the reception data signal by the receive weight of w=2 in a subcarrier of the resource block 2, and multiples the reception data signal by the receive weight of w=3 in a subcarrier of the resource block 3.

The channel estimator 242b has the same function as that of the channel estimator 242 of the first embodiment, but is different in the following point.

The channel estimator 242b calculates the representative value of the channel information on each weight unit. More specifically, the channel estimator 242b estimates the channel information on each subcarrier. The channel estimator 242b then averages the channel information, calculated on each subcarrier, by the weight unit to calculate the mean value as the representative value of the channel information.

The reception quality estimator 251b has the same function as the reception quality estimator 251 of the first embodiment, but is different in the following point.

The reception quality estimator 251b calculates a representative value of a reception quality on each weight unit. More specifically, the reception quality estimator 251b estimates the reception quality on each subcarrier. The reception quality estimator 251b averages the reception quality, calculated on each subcarrier, by the weight unit to calculate the mean value as the representative value of the reception quality.

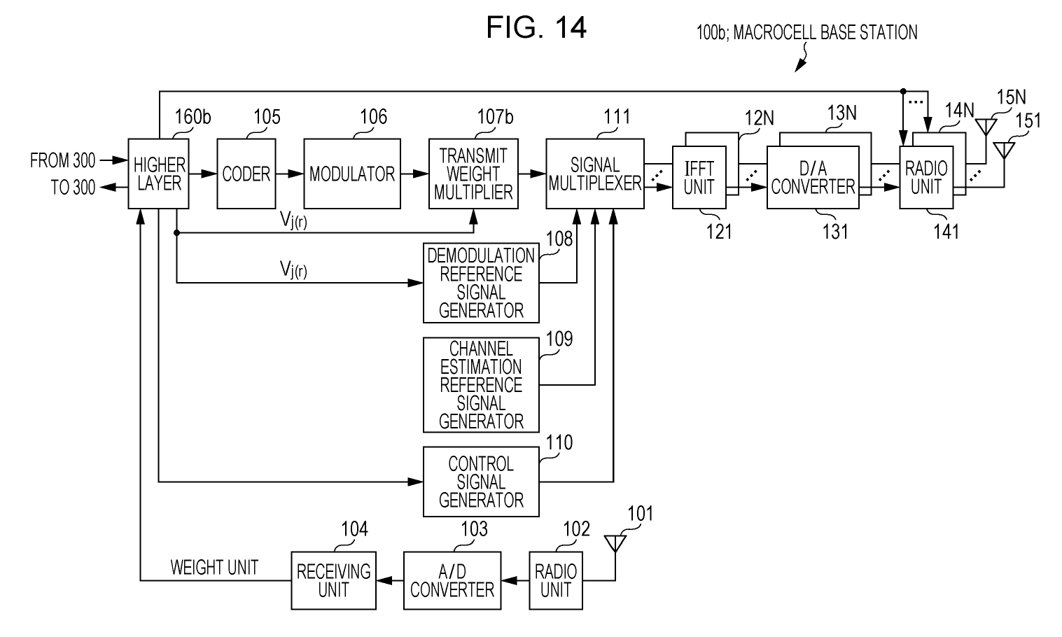

FIG. 14 is a block diagram diagrammatically illustrating the macrocell base station 100b of the second embodiment. Elements identical to those of FIG. 5 are designated with the same reference numerals and the specific discussion thereof is omitted herein. The configuration of the macrocell base station 100b of FIG. 14 is different from the configuration of the macrocell base station 100 of FIG. 5 in that the receiving unit 104 is replaced with the receiving unit 104b, that the transmit weight multiplier 107 is replaced with the transmit weight multiplier 107b, and that the higher layer 160 is replaced with the higher layer 160b.

The receiving unit 104b has the same function as that of the receiving unit 104 of the first embodiment, but is different from the receiving unit 104 in the following point.

The receiving unit 104b outputs to the higher layer 160 the weight unit included in the transmission signal transmitted from the macrocell terminal 200-1.

The transmit weight multiplier 107b has the same function as that of the transmit weight multiplier 107 of the first embodiment, but is different from the transmit weight multiplier 107 in the following point.

The transmit weight multiplier 107b multiplies a transmission bit train input from the modulator 106 by the same transmit weight on each weight unit.

More specifically, in the present embodiment, the transmission bit train is multiplied by a transmit weight of w=1 in the resource block 1, the transmission bit train is multiplied by a transmit weight of w=2 in the resource block 2, and the transmission bit train is multiplied by a transmit weight of w=3 in the resource block 3.

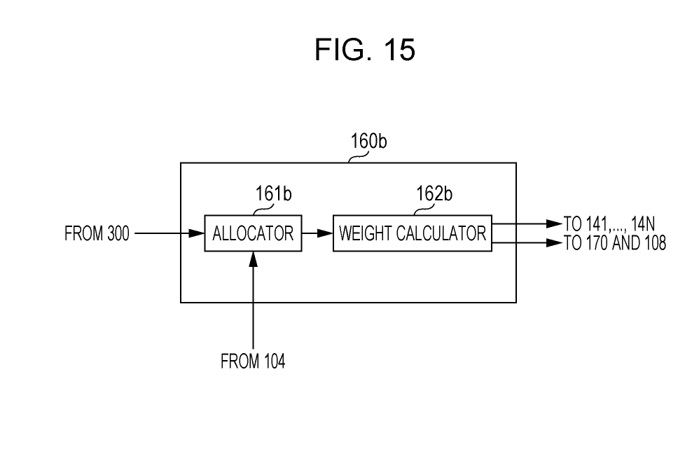

FIG. 15 is a block diagram diagrammatically illustrating the higher layer 160b of the second embodiment. The higher layer 160b includes an allocator 161b and a weight calculator 162b.

The allocator 161b determines the resource allocation based on the reception quality on each weight unit notified by each terminal. The allocator 161b outputs to the weight calculator 162b allocation results indicating determined resource allocations.

The weight calculator 162b acquires an allocated resource from the allocation results input from the allocator 161b. The weight calculator 162b calculates the transmit and receive weights on a per weight unit with respect to the resource allocated by the allocator 161b.

In connection with the subcarrier number m (1≦m≦subcarrier count) of the first embodiment (FIG. 9), in the present embodiment, the feedback number w (1≦w≦feedback count) is used and the feedback number w is substituted for the index m in Hkj(m) in the first embodiment.

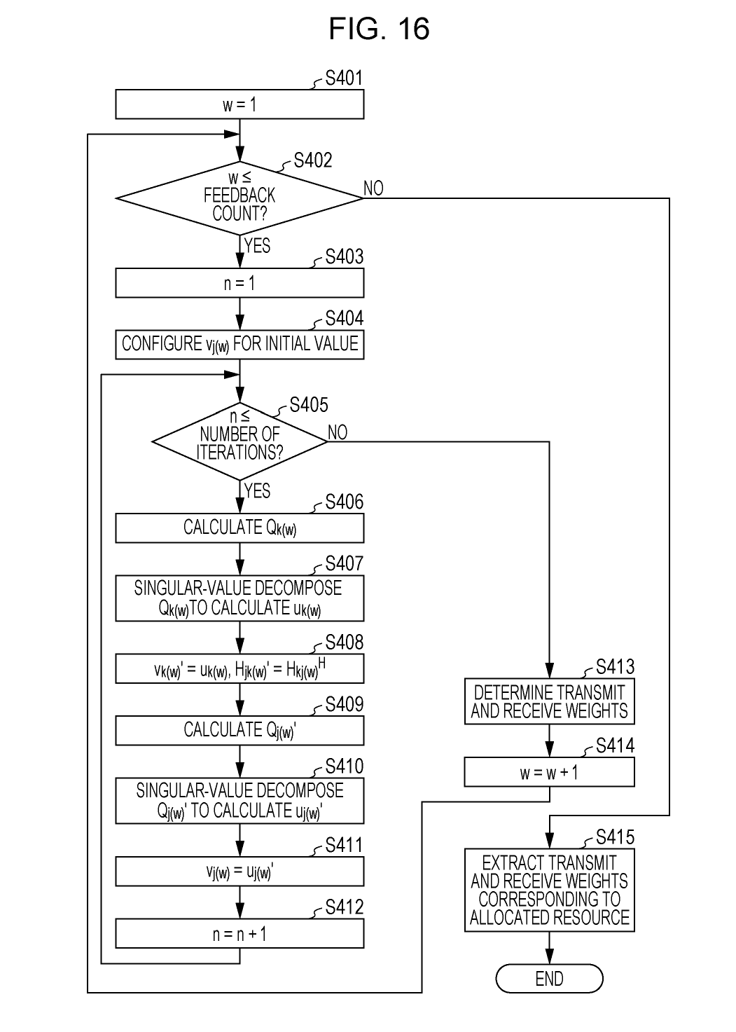

The flow of the calculation process of the transmit and receive weights in the present embodiment is described with reference to FIG. 16. FIG. 16 is a flowchart illustrating the flow of the calculation process of the transmit and receive weights of the second embodiment.

In step S401, the weight calculator 162b initializes the feedback number w to 1.

In step S402, the weight calculator 162b iterates operations in steps S403 through S414 to calculate the transmit and receive weights on a per weight unit basis in a case that the feedback number w remains equal to or below the feedback count. More specifically, the weight calculator 162b determines whether the feedback number w is equal to or below the feedback count. If the feedback number w is equal to or below the feedback count (yes branch from step S402), the weight calculator 162b proceeds to step S403. On the other hand, if the feedback number w is above the feedback count (no branch from step S402), the weight calculator 162b proceeds to step S415.

Steps S403 through S414 of FIG. 16 are respectively identical to steps S203 through S214 of FIG. 9, and an index as a process target is different. More specifically, as illustrated in FIG. 9, the weight calculator 162 calculates the transmit and receive weights on each subcarrier based on the subcarrier number m. Referring to FIG. 16, the weight calculator 162b calculates the transmit and receive weights on each feedback unit (weight unit) based on the feedback number w.

In step S415 of FIG. 16, the transmit and receive weights of RB1 through RB3 specified as the resource allocation are extracted from the transmit and receive weights calculated in step S413 (six weights in the present embodiment). The process of the flowchart is thus complete.

### Advantageous Effect of Second Embodiment

As described above, the macrocell base station 100b in the present embodiment calculates the transmit and receive weights on a per weight unit basis with respect to the allocated resource.

In addition to the advantageous effect of the first embodiment, the terminal apparatus 200b in the communication system 1b of the second embodiment calculates the channel information and reception quality back from the terminal apparatus 200b to the base station on a per weight unit basis, thereby reducing an amount of feedback to the base station.

The weight unit in the present embodiment is one resource block (12 subcarriers). The weight unit may be a natural number multiple of resource block. If the weight unit is specified to be tree resource blocks, the number of feedbacks from the terminal to the base station is 2 (the channel information and reception quality to be fed back are respectively the mean value of those of RB1 through RB3, and the mean value of those of RB4 through RB6). The centralized control station performs the resource allocation to RB1 through RB3 or RB4 through RB6, and the weight calculator 162b calculates single transmit and receive weight.

The weight unit in the present embodiment may be specified by the subcarrier count in place of by the resource block unit. A method of using a resource allocation unit different from a feedback control unit falls within the scope of the present invention. For example, the weight unit may be specified by a resource unit, such as every 16 subcarriers, different from the resource block. The weight unit may be changed depending on the frequency bandwidth. For example, one resource block may be specified in RB1 and RB2, and two resource blocks may be specified in RB3 through RB6. More specifically, the macrocell base station 100b may calculate the transmit weight and the receive weight by a unit equal to a natural number multiple of resource block. The macrocell base station 100b may calculate the transmit weight and the receive weight by multiple types of resource block units. For example, the weight calculation unit may be changed, such as a weight of w=1 for one resource block, and a weight of w=2 for two resource blocks. The weight calculation unit may be changed in view of frequency selectivity (frequency correlation) of a channel. For example, in a case that the frequency selectively is low, in other words, the frequency correlation is high, the weight calculation unit is increased, and in a case that the frequency selectivity is high, in other words, the frequency correlation is low, the weight calculation unit is decreased. The weight calculation unit varied in this way is appropriate in terms of computation reduction and transmission characteristics improvement. In other words, the macrocell base station 100b simply calculates the transmit weight and the receive weight on a per predetermined calculation unit basis.

The weight calculation unit that is larger than the feedback unit is acceptable. For example, the terminal apparatus 200b feeds back the channel information every resource block, and the macrocell base station 100b may determine the transmit and receive weights every two resource blocks. In such a case, the number of weights to be calculated is reduced, and an amount of computation of the macrocell base station 100b is reduced. An amount of control information that is used for the macrocell base station 100b to notify the terminal apparatus 200b of the weight is reduced. In another method, the weight calculation unit may be smaller than the feedback unit. For example, the terminal apparatus 200b feeds back the channel information every two resource blocks, and the macrocell base station 100b interpolates the feedback information to determine the weight every resource block. In such a case, the weight interval at which the macrocell base station 100b calculates the weight is narrowed. An error between an actual channel and the weight decreases, and the transmission characteristics thus improve.

In the present embodiment, the terminal apparatus 200b specifies the weight unit. Alternatively, the macrocell base station 100b may specify the weight unit. In such a case, the macrocell base station 100b transmits the weight unit to each base station. In this way, the weight unit is notified from each base station to each terminal apparatus 200b in communication therewith.

### Third Embodiment

In the first and second embodiments, the unit of calculation of the transmit and receive weights remains the same from the transmit weight to the receive weight. In a third embodiment, the transmit weight is a specified weight unit, and the receive weight is calculated on each subcarrier regardless of the weight unit. The third embodiment is not limited to the receive weight that is calculated on each subcarrier, and the terminal may generate the receive weight in a unit different from the weight unit.

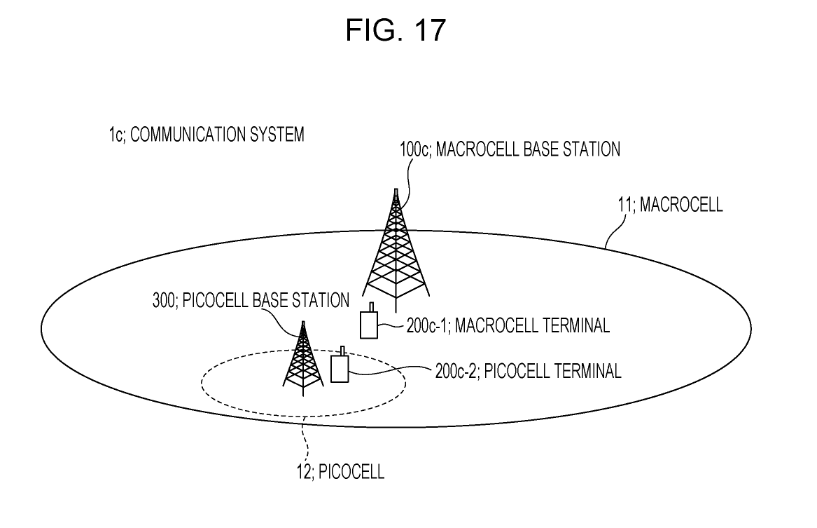

FIG. 17 illustrates a configuration example of a communication system 1c of the third embodiment. Elements identical to those in FIG. 2 are designated with the same reference numerals and the specific discussion thereof is omitted herein.

The configuration of the communication system 1c of FIG. 17 is different from the configuration of the communication system 1 of FIG. 2 in that the macrocell base station 100 is replaced with a macrocell base station (first base station apparatus) 100c, that the macrocell terminal 200-1 is replaced with a macrocell terminal 200c-1, and that the picocell terminal 200b-2 is replaced with a picocell terminal 200c-2.

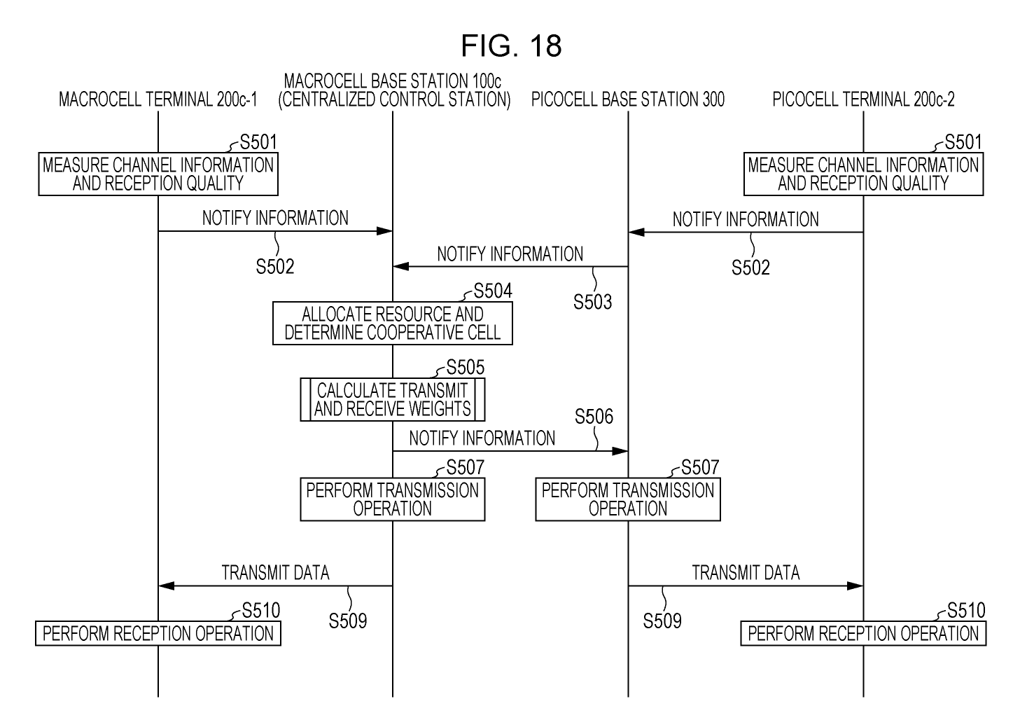

The following discussion of the configuration of the present embodiment focuses on only a difference between the third embodiment and the first and second embodiments. FIG. 18 is a flowchart illustrating an example of a process flow of the communication system of the third embodiment. The process flow of the communication system 1c of the third embodiment is different from the process flow of the communication system 1 of the first embodiment in that the macrocell base station 100c of the third embodiment needs only the transmit weight. Since steps S501 through S504 and steps S507 and S509 are respectively identical to steps S101 through S104 and steps S107 and S109 of FIG. 4, the discussion thereof is omitted herein. The difference of the third embodiment from the first embodiment is described with reference to FIG. 18.

In step S505, the macrocell base station 100c calculates the transmit weight and resource allocation. In step S506, the macrocell base station 100c notifies the picocell base station 300 of the transmit weight and resource allocation calculated in step S505 via the wired network. In other words, the macrocell base station 100c does not notify each terminal of the receive weight calculated in step S505.

In step S510, each terminal receives the signal transmitted from the base station connected thereto, thereby performing a reception process. Each terminal thus calculates the receive weight based on the received signal. Each terminal reconstructs a transmission signal by multiplying the reception data signal by the calculated receive weight.

If there are multiple base stations excluding the centralized control station, the macrocell base station 100c notifies all the base stations other than the centralized control station of the transmit weight and resource allocation calculated in step S105.

In step S108 of FIG. 4 in the first and second embodiments, each base station notifies a terminal connected thereto of the receive weight. But in the third embodiment, each base station does not notify a terminal connected thereto of the receive weight.

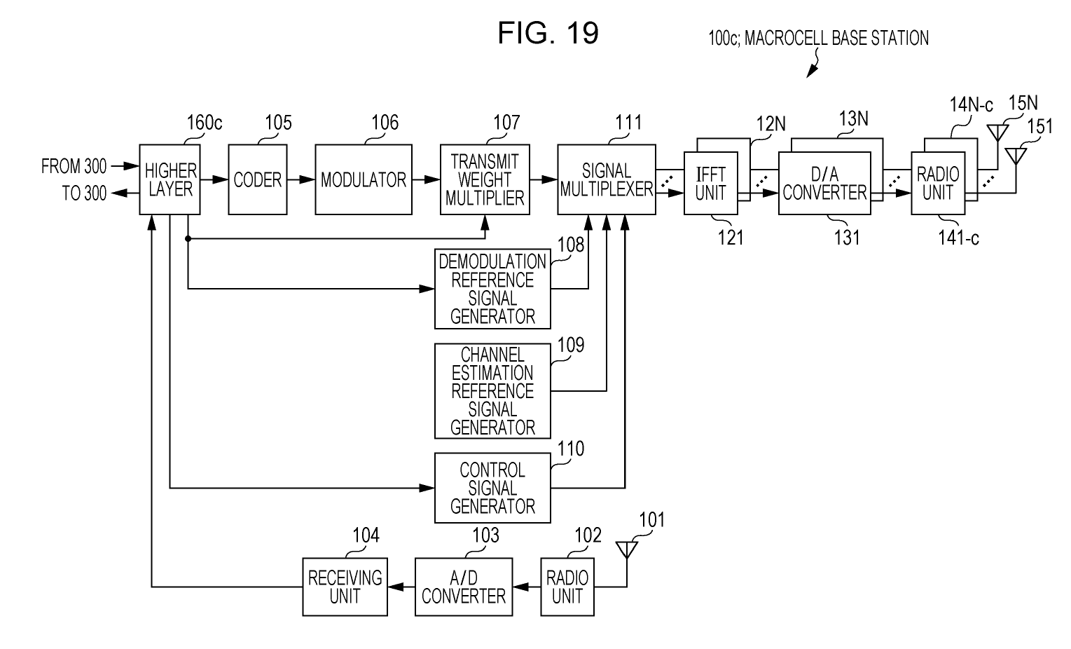

FIG. 19 is a block diagram diagrammatically illustrating the macrocell base station 100c of the third embodiment. Elements identical to those of FIG. 5 are designated with the same reference numerals and the discussion thereof is omitted herein.

The configuration of the macrocell base station 100c of FIG. 19 is different from the configuration of the macrocell base station 100 of FIG. 5 in that the higher layer 160 is replaced with the higher layer 160c, and that the radio units 141, . . . , and 14N are respectively replaced with the radio units 141-c, . . . , and 14N-c.

The higher layer 160c has the same function as that of the higher layer 160 of the first layer, but is different in the following point. The higher layer 160c calculates the transmit weight and resource allocation. The higher layer 160c neither calculates the receive weight nor outputs the receive weight to the radio units 141-c, . . . , and 14N-c. The radio units 141-c, . . . , and 14N-c do not transmit the receive weight to the macrocell terminal 200-1.

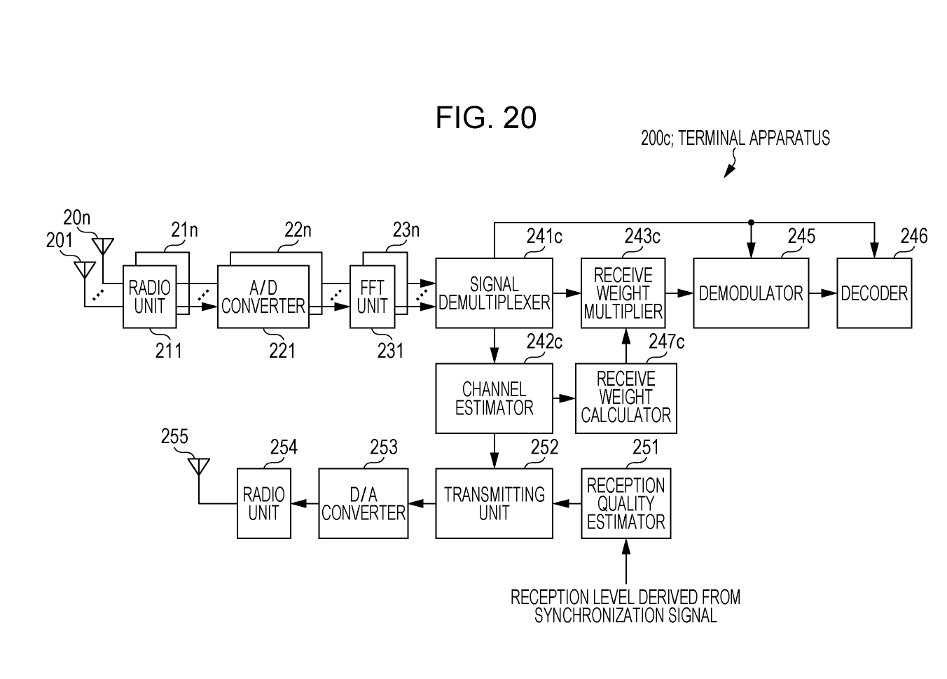

FIG. 20 is a block diagram diagrammatically illustrating a terminal apparatus 200c of the third embodiment. Elements identical to those of FIG. 8 are designated with the same reference numerals and the specific discussion thereof is omitted herein.

The configuration of the terminal apparatus 200c of FIG. 20 is different from the configuration of the terminal apparatus 200 of FIG. 8 in that a receive weight calculator 247c is added, that the signal demultiplexer 241 is replaced with a signal demultiplexer 241c, that the channel estimator 242 is replaced with a channel estimator 242c, and that the receive weight multiplier 243 is replaced with a receive weight multiplier 243c. With respect to the first and second embodiments, the third embodiment includes the receive weight calculator 247c.

The signal demultiplexer 241c demultiplexes an input signal into the reference signals (the demodulation reference signal and the channel estimation reference signal) and the control signal. The signal demultiplexer 241c outputs the reference signals to the channel estimator 242c. The signal demultiplexer 241c outputs to the receive weight multiplier 243c the reception data signal that remains after the reference signals and the control information are separated from the input signal. The signal demultiplexer 241 outputs the control information to a receive weight multiplier 243c, a demodulator 245c, and a decoder 246c.

The channel estimator 242c calculates equivalent channel information H″k(m) on each subcarrier, and outputs the calculated equivalent channel information H″k(m) on each subcarrier to the receive weight calculator 247c.

The receive weight calculator 247c calculates the receive weight in accordance with the equivalent channel information H″k(m) on each subcarrier input from the channel estimator 242c, for example, in accordance with the following Formula (4).

[Math. 4]

uₖ₍ₘ₎=Hₖ₍ₘ₎^{″H}(Hₖ₍ₘ₎^{′}Hₖ₍ₘ₎^{′H}+σₖ²I)⁻¹ (4)

In Formula (4), σk2 is the mean power of noise at terminal k, and I is a unit matrix. Formula (4) represents the receive weight based on MMSE (Minimum Mean Square Error) standards, but another receive weight may be used. The receive weight calculator 247c outputs the calculated receive weight to the receive weight multiplier 243c.

The receive weight multiplier 243c multiples the reception data signal input from the signal demultiplexer 241 by the receive weight input from the receive weight calculator 247c, and outputs the signal as a result of multiplication to the demodulator 245.

### Advantageous Effect of Third Embodiment

In addition to the advantage of the first embodiment, the present embodiment enjoys the advantage that the notification of the receive weight from each base station to a terminal connected thereto becomes unnecessary. An amount of communication traffic from each base station to the terminal is thus reduced. Since each terminal calculates the receive weight based on the equivalent channel estimated on the terminal, the effect of a feedback error on a channel is reduced.

In a case that the macrocell base station 100c calculates the transmit and receive weights on a subcarrier unit and notifies the terminal of the receive weight, the receive weight may be decimated by the weight unit. In this way, the macrocell base station 100c reduces an amount of communication of the receive weight.

Even with the receive weight notified, the terminal apparatus 200c may calculate the weights by the subcarrier unit. An error may occur between a channel from which the macrocell base station 100c calculates the weight and a channel from which the terminal apparatus 200c receives, for example, in a case that the terminal apparatus 200c is moving. The effect of the error may be reduced.

In the third embodiment, the terminal apparatus 200c calculates the weight by the subcarrier unit. The present invention is not limited to this method. The receive weight may be calculated by a unit different from the calculation unit of the transmit weight. Such a method also falls within the present invention. For example, in a case the macrocell base station 100c calculates the transmit weight every two resource blocks, the terminal apparatus 200c may calculate the receive weight every resource block or every three resource blocks. A larger receive weight calculation unit of the terminal apparatus 200c leads to a smaller amount of computation. A smaller receive weight calculation unit leads to more improved transmission characteristics.

A program to execute each process on the base station and the terminal in the present embodiment may be recorded on a computer readable recording medium, the program may be read from the recording medium to a computer system. The computer system then execute the program, thereby performing the variety of processes of the base station and the terminal described above.

The “computer system” may include OS, and hardware such as a peripheral device. In a case that the WWW system is used, the “computer system” includes a home page providing environment (or a home page displaying environment). The “computer readable recording media” include a recordable non-volatile memory, such as a flexible disk, a magneto-optical disk, ROM, or a flash memory, a removable medium, such as CD-ROM, and a storage device, such as a hard disk, built in the computer system.

The “computer readable recording media” include a recording medium, temporarily storing the program for a predetermined period of time, such as a volatile memory (like DRAM (Dynamic Random Access Memory)) in the computer system, like a server or a computer system serving as a client in a case that the program is transmitted via a communication network, such as the Internet or a telephone line. The program may be transmitted from the computer system having a storage device storing the program to another computer system via a transmission medium or a transmitting wave in the transmission medium. The “transmission medium” to transmit the program refers to a medium, such as a network (communication network) including the Internet, or a communication line such as a telephone line, having a function of transmitting information. The program may implement part of the above described function. The program may be a difference file (difference program) which implements the above described function in combination with a program pre-stored on the computer system.

The embodiments of the present invention have been described in detail with reference to the drawings. The present invention in a specific configuration is not limited the embodiments. The present invention is not limited in configuration to the configuration illustrated in the drawings. The embodiments may be modified within the scope where the advantageous effect of the present invention is implemented. The embodiments may be modified without departing from the scope of the present invention.

### REFERENCE SIGNS LIST

1, 1b, and 1c Communication systems
100, 100b, and 100c Macrocell base stations (first base stations)
101 Receive antenna
102 Radio unit
103 A/D converter
104 Receiving unit
105 Coder
106 Modulator
107 Transmit weight multiplier
108 Demodulation reference signal generator
109 Channel estimation reference signal generator
110 Control signal generator
111 Signal multiplexer
121, . . . , and 12N IFFT units
131, . . . , and 13N D/A converters
141, . . . , 14N, and 141-c, . . . , and 14N-c Radio units (transmitting units)
151, . . . , and 15N Transmit antennas
160, 160-2, 160b, and 160c Higher layers
161 and 161b Allocators
162 and 162b Weight calculators
200, 200b, and 200c Terminal apparatuses
200-1, 200b-1, and 200c-1 Macrocell terminals
200-2, 200b-2, and 200c-2 Picocell terminals
201, . . . , and 20N Receive antennas
211, . . . , and 21n Radio units
221, . . . , and 22N A/D converters
231, . . . , and 23N FFT units
241, and 241c Signal demultiplexers
242, and 242c Channel estimator
243, and 243c Receive weight multipliers
245 Demodulator
246 Decoder
247c Receive weight calculator
251 Reception quality estimator
252 Transmitting unit
253 D/A converter
254 Radio unit
255 Transmit antenna
300 Picocell base station

1-29. (canceled)

30. A base station apparatus for communicating with a terminal apparatus using a plurality resources, configured to calculate transmit weights of a plurality of base station apparatuses with respect to the terminal apparatus having the same resource of the resources allocated thereto, and configured to transmit the transmit weights to the other base station apparatuses.

31. The base station apparatus according to claim 30, wherein the base station apparatus further calculates receive weights of a terminal apparatus in communication therewith, and of terminal apparatuses in communication with the other base stations, and transmits the receive weights to the other base stations.

32. The base station apparatus according to claim 30, wherein the base station apparatus calculates the transmit weight by a weight unit serving as a unit of weight calculation.

33. The base station apparatus according to claim 32, wherein the weight unit is a subcarrier unit.

34. The base station apparatus according to claim 32, wherein the weight unit is a unit that is a natural number multiple of a resource block.

35. The base station apparatus according to claim 30, wherein the base station apparatus transmits the transmit weights to the other base stations through a wired network or a radio network.

36. A transmission method of a base station apparatus for communicating with a terminal apparatus using a plurality resources, comprising calculating transmit weights of a plurality of base station apparatuses with respect to the terminal apparatus having the same resource of the resources allocated thereto, and transmitting the transmit weights to the other base station apparatuses.

37. A terminal apparatus comprising a radio unit configured to receive a signal multiplied by a transmit weight that is calculated by a weight unit serving as a unit of weight calculation, a receive weight calculator configured to calculate a receive weight by a unit different from the weight unit, and a receive unit multiplier configured to multiply a reception signal by the receive weight.

38. The terminal apparatus according to claim 37, wherein the weight unit of the receive weight is a subcarrier unit.

39. A reception method of a terminal apparatus, comprising receiving a signal multiplied by a transmit weight that is calculated by a weight unit serving as a unit of weight calculation, calculating a receive weight by a unit different from the weight unit, and multiplying a reception signal by the receive weight.
